(19) United States
(12) Patent Application Publication
(10) Pub. No.: US 2002/0133324 A1
(43) Pub. Date: Sep. 19, 2002

(54) Functional simulation method

(76) Inventors: James C. Weaver, Sudbury, MA (US); Thiruvalluv R. Gowrishankar, Tewksbury, MA (US); Gregory T. Martin, Cambridge, MA (US); Donald Arthur Stewart JR., Hingham, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/011,920

(22) Filed: Nov. 5, 2001

Related U.S. Application Data
(60) Provisional application No. 60/245,609, filed on Nov. 3, 2000.

(51) Int. Cl. G06F 17/50

(52) U.S. Cl. 703/14

(57) ABSTRACT

Systems and methods for modeling multidimensional physical systems, including biological and chemical systems. A system to be treated as a model is represented by a geometrical structure. The geometry is superposed onto a lattice template. Functional elements are obtained to express relationships between portions of the system to be modeled. The functional elements are assigned to lattice regions. The initial conditions, boundary conditions and constraints on the model are specified. The lattice is solved using a circuit simulation package. The quantities determined for the circuit are used to compute system quantities. Optionally the computer information is displayed. Optionally, the system is modeled as multiple lattices, which can be solved either serially (iteratively) or in parallel, to obtain a consistent solution.

### CROSS-REFERENCE TO RELATED APPLICATIONS

This application claims the benefit of U.S. provisional patent application Serial No. 60/245,609, filed Nov. 3, 2000, which application is incorporated herein in its entirety by reference.

### GOVERNMENT RIGHTS

This invention was made with government support under Grant No. AR 42921 awarded by the National Institutes of Health. The government may have certain rights in the invention.

### FIELD OF THE INVENTION

This invention relates generally to systems and methods for simulation of physical systems. More particularly, the invention relates to systems and methods for modeling three dimensional biological and chemical systems using three dimensional lattice circuit simulation.

### BACKGROUND OF THE INVENTION

Simulation of physical systems is used to predict or to analyze the properties of complex systems. In the electrical arts, such simulations can be performed on models of circuits, using computer-based methods of solution such as the Simulation Program with Integrated Circuit Emphasis (“SPICE”) computer program. Other computer programs for solving simulations are also available.

Models are known to have various shortcomings. For example, two-dimensional models of three dimensional objects inherently involve the loss of information as to the dimension not modeled. To the extent that models involve approximations, either to simplify the mathematics of calculation, or to simplify the representation of the object or system being modeled, the solution obtained will be somewhat inaccurate or incomplete. For systems that exhibit variations over time, or that exhibit variations between different examples of the same species, models will provide limited information.

### SUMMARY OF THE INVENTION

The systems and methods of the invention provide three dimensional lattice circuit simulations of complex biological and chemical systems. The invention allows the construction of models that provide a full description of the structural features of system or object to be modeled. The invention further provides a convenient method for performing lattice circuit analyses of objects or systems that vary with time, and/or that vary from one example to another within a species. The systems and methods of the invention provide the ability to simulate models that incorporate variability. For example, the invention allows the use of different values or magnitudes of parameters that describe the functional elements of the model in different modeling calculations. The invention further allows the use of different geometric lattice representations of the model, including variation with respect to geometric form and variation with respect to the distances between the lattice nodes of the representation. The invention additionally provides solutions for the behavior of systems that are traditionally viewed as unpredictable, such as biological and chemical systems. For example, the invention allows the solution of an ensemble of examples, from which a statistical understanding of the problem being modeled can be derived. Different methods of choosing such an ensemble are well known in the mathematical modeling arts.

In one aspect, the invention features a method for generating a computer-based digital representation of a physical system as an electrical circuit. The method includes providing a three-dimensional lattice of circuit elements defined on a plurality of geometrical points. The three-dimensional lattice of circuit elements is representative of a portion of a physical system to be simulated. The method includes the step of associating with the portion of the three-dimensional lattice a transport function representative of the physical system. The method includes providing a quantitative description of the transport function, so as to generate the computer-based digital representation of the electrical circuit simulation of the physical system.

The method further includes the step of providing an initial condition for at least one circuit element. In one embodiment, the initial condition is a selected one of a voltage, a difference in voltage, a current, and a charge. In one embodiment, the selected one of a voltage, a difference in voltage, a current and a charge represents a physical quantity characteristic of the physical system. In one embodiment, the physical quantity characteristic of the physical system is at least one of a chemical quantity, a physical quantity, and a biological quantity. In one embodiment, the at least one of a chemical quantity, a physical quantity, and a biological quantity is a selected one of an amount of material, a concentration of a first material in a second material, a flow of material, a flux of material, a temperature, a pressure, a volume, a time, a frequency, an intensity of electromagnetic radiation, a wavelength of electromagnetic radiation, a potential difference, a diffusion coefficient, and a gradient.

In some embodiments, the method further includes the step of solving the circuit to determine a behavior of the circuit. In some embodiments, the method further includes the step of translating a value obtained from solving the circuit to a physical quantity indicative of a solution of the transport function in the physical system to be simulated. In some embodiments, the plurality of geometrical points is based on a selected one of an image, a drawing, and a shape. In some embodiments, the shape is a selected one of a graphical shape, a shape defined by an equation, and a shape defined by a numerical representation. In some embodiments, the shape is a member of a library of shapes.

In some embodiments, the physical system comprises a system having a biological component. In some embodiments, the physical system comprises a system having a chemical component.

In another aspect, the invention relates to a computer-based digital system for generating a representation of a physical system as an electrical circuit. The system includes a lattice module that provides a three-dimensional lattice of circuit elements defined on a plurality of geometrical points, the three-dimensional lattice of circuit elements representative of a portion of a physical system to be simulated. The system includes a function module that associates a transport function representative of the physical system with a portion of the three-dimensional lattice. The system includes a description module that provides a quantitative description of the transport function in the portion, so as to generate the computer-based digital representation of the simulated electrical circuit as a physical system.

In some embodiments, the system further includes an initiation module that provides an initial condition for at least one circuit element. In some embodiments, the initial condition is a selected one of a voltage, a difference in voltage, a current, and a charge. In some embodiments, the selected one of a voltage, a difference in voltage, a current and a charge represents a physical quantity characteristic of the physical system.

In some embodiments, the physical quantity characteristic of the physical system is at least one of a chemical quantity, a physical quantity, and a biological quantity. In some embodiments, the at least one of a chemical quantity, a physical quantity, and a biological quantity is a selected one of an amount of material, a concentration of a first material in a second material, a flow of material, a flux of material, a temperature, a pressure, a volume, a time, a frequency, an intensity of electromagnetic radiation, a wavelength of electromagnetic radiation, a potential difference, a diffusion coefficient, and a gradient.

In some embodiments, the system further includes a solution module that solves the circuit to determine a behavior of the circuit. In some embodiments, the system further includes a translation module that translates a value obtained from solving the circuit to a physical quantity indicative of a solution of the transport function in the physical system to be simulated.

In some embodiments, the plurality of geometrical points is based on a selected one of an image, a drawing, and a shape. In some embodiments, the shape is a selected one of a graphical shape, a shape defined by an equation, and a shape defined by a numerical representation. In some embodiments, the shape is a member of a library of shapes. In some embodiments, the physical system comprises a system having a biological component. In some embodiments, the physical system comprises a system having a chemical component.

In a further aspect, the invention features a computer-based digital system for generating a representation of a physical system as an electrical circuit. the system includes a means for providing a three-dimensional lattice of circuit elements defined on a plurality of geometrical points, the three-dimensional lattice of circuit elements representative of a portion of a physical system to be simulated; a means for associating a transport function representative of the physical system with a portion of the three-dimensional lattice; and a means for providing a quantitative description of the transport function in the portion, so as to generate the computer-based digital representation of the simulated electrical circuit as a physical system.

In some embodiments, the system further includes a means for providing an initial condition for at least one circuit element. In some embodiments, the initial condition is a selected one of a voltage, a difference in voltage, a current, and a charge. In some embodiments, the selected one of a voltage, a difference in voltage, a current and a charge represents a physical quantity characteristic of the physical system. In some embodiments, the physical quantity characteristic of the physical system is at least one of a chemical quantity, a physical quantity, and a biological quantity.

In some embodiments, the at least one of a chemical quantity, a physical quantity, and a biological quantity is a selected one of an amount of material, a concentration of a first material in a second material, a flow of material, a temperature, a pressure, a volume, a time, a frequency, an intensity of electromagnetic radiation, a wavelength of electromagnetic radiation, a potential difference, a diffusion coefficient, and a gradient. In some embodiments, the system further includes a means for solving the circuit to determine a behavior of the circuit.

In some embodiments, the system further includes a means for translating a value obtained from solving the circuit to a physical quantity indicative of a solution of the transport function in the physical system to be simulated.

In some embodiments, the plurality of geometrical points is based on a selected one of an image, a drawing, and a shape. In some embodiments, the shape is a selected one of a graphical shape, a shape defined by an equation, and a shape defined by a numerical representation. In some embodiments, the shape is a member of a library of shapes. In some embodiments, the physical system comprises a system having a biological component. In some embodiments, the physical system comprises a system having a chemical component.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic flow diagram that depicts the steps in the method, according to an embodiment of the invention;

FIG. 2A is a fluorescence microscopy image of a fibroblast;

FIG. 2B is an illustrative two-dimensional model of the fibroblast shown in

FIG. 2A, in which two regions of the nuclear membrane are electroporated (shown in white), according to an embodiment of the invention;

FIG. 2C is the same illustrative two-dimensional model of the fibroblast shown in FIG. 2A, in which multiple regions of the outer, plasma membrane are electroporated (shown in white), according to an embodiment of the invention;

FIG. 2D shows an illustrative electrolyte functional element between adjacent nodes, according to an embodiment of the invention;

FIG. 2E shows an illustrative model of membrane segments, according to an embodiment of the invention;

FIG. 3A is an illustrative perspective drawing of a spherical cell confined between parallel plane electrodes in a physiologic fluid, according to an embodiment of the invention;

FIGS. 3B-3J show an illustrative solution in frequency space for a uniform field applied to the spherical cell of FIG. 3A, according to an embodiment of the invention;

FIG. 4A is a perspective drawing of a spherical cell enclosed within a planar electrode and a small pointed microelectrode;

FIGS. 4B(1)-4B(29) are illustrative equipotentials along plane surfaces running perpendicular to the plane electrodes symmetrically on either side of the central slice through the simulation geometry, according to an embodiment of the invention;

FIG. 5 is the Hodgkin-Huxley squid giant axon equivalent circuit;

FIG. 6A is an exploded view of three two dimensional lattice circuits, according to an embodiment of the invention;

FIG. 6B is a perspective drawing of an illustrative three dimensional 3×3×200 lattice circuit used to model the current clamped axon, according to an embodiment of the invention;

FIG. 7 shows the results of an illustrative simulation as a plot of the transmembrane potential (Uₘ) as a function of time, according to an embodiment of the invention;

FIG. 8 shows an illustrative 7×7×100 lattice along the axis of a non-myelinated axon, according to an embodiment of the invention;

FIG. 9 shows the results of a simulation of an axon exposed to an external field in the range of 100 to 800 mV, according to an embodiment of the invention;

FIGS. 10A through 10F show plots of the transmembrane potential (Um) for a damaged axon as a function of distance along an axon, for different fractional changes in membrane conductivity in the damaged region, according to an embodiment of the invention;

FIG. 11 shows an illustrative model, in which two axons are modeled within a 70 μm×70 μm×2.5 mm volume, according to an embodiment of the invention;

FIGS. 12A through 12F show illustrative plots of the transmembrane potential (Um) for different stimulation potentials in the range of 50 mV to 1500 mV, according to one embodiment of the invention;

FIG. 13A shows an illustrative model of an electrically heated catheter within a lumen filled with blood, according to one embodiment of the invention;

FIG. 13B shows the temperature distribution and some isotherms obtained from solving the model of FIG. 13A, according to an embodiment of the invention;

FIG. 13C is an illustrative lattice circuit used to model the electrically heated catheter within a lumen filled with blood, according to an embodiment of the invention;

FIG. 14A is a histological image of a specimen of skeletal muscle tissue;

FIGS. 14B through 14E show an illustrative time sequence of electroporation of a skeletal muscle tissue model system, according to an embodiment of the invention;

FIG. 14F is an illustrative lattice circuit used to model the skeletal muscle tissue system, according to an embodiment of the invention;

FIG. 15A is a histological image of a specimen of skin;

FIG. 15B is an illustrative model created from the image shown in FIG. 15A, according to an embodiment of the invention;

FIG. 15C is a temperature distribution deduced for the illustrative model of FIG. 15B, according to an embodiment of the invention;

FIG. 15D is a schematic diagram of an equivalent circuit used to model the skin, including the effects of heat conduction and of and perfusion, according to an embodiment of the invention;

FIG. 16A is a cross sectional drawing of the skin;

FIG. 16B is an illustrative circuit segment used to model skin, according to an embodiment of the invention;

FIGS. 17A-17D show an illustrative time evolution of a model of a drug dispensed into skin, according to an embodiment of the invention;

FIG. 18 shows an illustrative result of the model with regard to the location of the dosed medication as a function of time, according to an embodiment of the invention;

FIG. 19A is an optical coherence tomography image of a human coronary artery with a cholesterol rich vulnerable plaque;

FIG. 19B is an illustrative two-dimensional model generated from the image shown in FIG. 19A, according to an embodiment of the invention;

FIG. 19C is an illustrative lattice circuit used to model the human coronary artery with a cholesterol rich vulnerable plaque, according to an embodiment of the invention;

FIG. 20A is a drawing of a tissue;

FIGS. 20B(1)-20B(9) show an illustrative distribution of specific absorption rate (SAR) for electric field frequencies from 10 Hz to 1 GHz in steps of a decade, according to an embodiment of the invention;

FIGS. 20C(1)-20C(9) depict illustrative isotemperature contours corresponding to the SAR images of FIGS. 20B(1)-20B(9), according to an embodiment of the invention;

FIG. 21A is a diagram of a system that models the molecular transport of a chemical substance through a gradually opening valve, according to an embodiment of the invention;

FIGS. 21B through 21H are diagrams showing the time evolution of the molecular transport process with time; and

FIG. 21I is an illustrative lattice circuit used to model the system with the gradually opening valve, according to an embodiment of the invention.

### DETAILED DESCRIPTION

The methods of this invention can be used iteratively, employing a model or representation of a physical system with an initial assignment of functional elements with particular parametric values, initial conditions and boundary conditions. In some cases, the process is carried out multiple times, using a range of parametric values. The simulation results are then compared in part, or in full, to experimental measurements and observations made either on the real system that motivated the physical system model, or on another real system that is similar to the one that motivated the physical system model.

For example, a representation or model of human or animal skin can be made from a drawing that represents general knowledge about skin, or from an image of a skin specimen. In the context of the model, molecules such as drug molecules, irritant molecules, toxic molecules, enhancer molecules that alter the skin transport properties, or other chemicals can be placed in one or more trial application locations. The simulation provides results that include the amount or flux of molecule into blood capillaries. The same simulation usually also contains information that predicts the time dependent concentration of drug at different locations within the model. Experiments typically measure total drug contained within a tissue sample volume. The simulation results can also be integrated over selected regions or volumes to provide corresponding predictions of the total amount of drug in the selected sample volume, and the prediction is compared to the experimental result. Depending on the closeness of agreement, the model's parameters can be altered, and/or additional circuit elements can be added to the simulation. Additional simulations are carried out with the new parameters and/or circuit elements. In some cases the simulation can be used to predict behavior of surrogate molecules such as fluorescent or radioactive tracer molecules that have diffusion coefficients and partition coefficients close to those of the drug molecule. In this case iterative use of simulations and experiments involving surrogate molecules can then be used with related simulations that use known or estimated properties of the drug. This iterative process involving simulation and experiment leads to improved models.

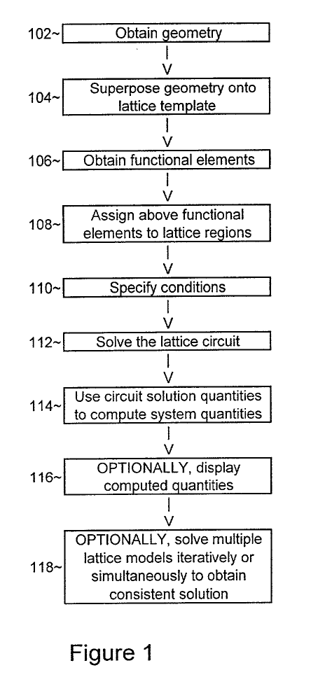

FIG. 1 is an exemplary flow diagram that illustrates a method of and a system for practicing the invention. The methods and systems of the invention are practiced using a digital computer programmed with software. As is well known in the computer arts, it is also possible to provide hard-wired circuitry, or programmable circuitry, that contains some or all of the instructions in a computer program. The computer can be any general purpose computer, such as a personal computer, a laptop computer, a minicomputer, a mainframe computer, or similar computational devices. The computer includes some or all of the commonly used peripheral devices such as input devices (e.g., a keyboard, a mouse, a light pen, a touch screen), output devices (e.g., a display screen, a printer, a speaker), and storage devices (e.g., floppy disks, hard disks, CD-ROMs, optical storage, magnetic tape, memories including semiconductor memory, and similar devices). The computer can operate as a stand-alone computer or as part of a network.

As indicated by box 102, the system includes a module that allows a user or a programmed computer to define a geometrical description of a system to be modeled, or equivalently a step of a method in which a geometry is selected or defined. The geometrical description can come from an image (such as a three dimensional volumetric image, or a two dimensional section of an object), from a drawing, from geometric shapes, from equations that define a geometry, from a library of standard geometries, or from previously defined geometries.

As indicated by box 104, the system includes a module, and the method includes a step, in which a user or a programmed computer superposes (i.e., maps, overlays) the geometry onto a lattice template. The lattice can be two- or three-dimensional.

As indicated by box 106, the system includes a module, and the method includes a step, in which a user or a programmed computer obtains at least two functional elements that are characteristic of the object or system to be modeled. Functional elements, such as transport models in the case of charge, heat and molecular transport, and which can also include storage of charge, heat, and material, define a relationship by which modeled quantities are expected to behave.

As indicated by box 108, the system includes a module, and the method includes a step, in which a user or a programmed computer assigns different functional elements to different regions of the lattice. The assignment process specifies the functional elements that are connected between nodes, or between a node and a reference point, such as electrical ground in the case of a circuit. In different kinds of physical systems, the transport properties that are assigned to different regions of the model can be selected from many different fields of study.

For example, transport properties can be selected from diffusion coefficients, partition coefficients, thermal conductivities, heat capacities, electrical resistivities, dielectric constants, cell membrane properties and functions, chemical reaction kinetics such as enzyme kinetics, phase transitions, models for action potentials, models for chemical potential-dependent diffusion coefficients, chemical potential-dependent partition coefficients, voltage, temperature or chemical potential-dependent transitions (i.e., switching behavior as a function of electrical, thermal, or chemical stimuli), dissolution and/or crystallization within liquids, evaporation, condensation, sublimation, and other physical characteristics that are well known to those of skill in the sciences and engineering disciplines. Other examples of transport functions can be envisioned. For example, mechanical strain in response to mechanical stress can be understood as a transport function. Mechanical strain is in this case thought of as a type of transport.

As indicated by box 110, the system includes a module, and the method includes a step, in which a user or a programmed computer specifies conditions for the object or system to be modeled. The conditions include initial conditions, boundary conditions, and/or times at which one or more conditions change. For example, initial conditions include such physical quantities or values as voltages, temperatures, concentrations, amounts, or activities. As examples, boundary conditions include conservation equations, such as conservation of mass, energy, or charge, electrical stimulus parameters such as electrical pulse magnitude, rise time and width, or a moving or time-dependent boundary such as the movement of a valve part. Furthermore, conditions defined for the simulation can include the time dependence of elements on time generated by a clock, and other simulation parameters such as time step size, and frequency range for sinusoidal stimuli. Specification of conditions can also include specification of one or more timers or clocks whose outputs define times that begin or end specified events.

As indicated by box 112, the system includes a module, and the method includes a step, in which a user or a programmed computer solves the lattice circuit. As is well known in the computer arts, various software packages are available that can solve circuits. One such program is SPICE, which is available in different variants from a number of public sources, such as The University of California at Berkeley (Berkeley Spice 3f4, July 1993, ftp://ic.eecs.berkeley.edu/pub/Spice), and commercial vendors, including MicroSim, and which is operable on many different commercially available computers operating under a variety of operating systems. Other software packages that can solve circuits are also known to those of skill in the software and electrical engineering arts.

As indicated by box 114, the system includes a module, and the method includes a step, in which a user or a programmed computer uses the nodal values and intranodal fluxes to compute system quantities from the circuit solutions. The quantities which are computed depend on the particular problem that is being simulated, and include quantities corresponding to the conditions specified in box 110. In particular, such quantities as concentrations or activities, chemical or molecular flux, temperature, heat flux, potentials, equipotentials, voltages, current densities, stored charge, transmembrane voltages, and specific absorption rates (SAR) can be computed, as will be described in further detail below.

As indicated by box 116, the system includes a module, and the method includes a step, in which a user or a programmed computer optionally displays one or more computed quantities determined in box 114.

As indicated by box 118, the system includes a module, and the method includes a step, in which a user or a programmed computer optionally solves multiple lattice problems iteratively or simultaneously to obtain a consistent solution. In an iterative solution of a simulation using multiple lattice models (e.g., two or more interacting lattices), one can use appropriate quantities computed as an initial solution of a first lattice as input into a second lattice. The solution obtained from the next lattice is then used to provide input for another lattice. If there are no additional lattices, the input is used for the first lattice. Repeated iterations may be performed until a consistent solution is found. Commonly, one ceases computation when the difference between the output obtained from successive iterations is less than a predefined quantity.

In this analysis, two types of multiple lattices are distinguished. The first involves multiple lattices whose simulations are solved sequentially, as described above. An example is an iterative solution of an electrical/thermal lattice pair. In such a case the electrical lattice is usually solved first, obtaining electrical power dissipation between nodes. The result is used as a spatially distributed power input to the nodes of the companion thermal lattice. Solution of the thermal lattice yields a temperature distribution. The temperature distribution is used to change the values or properties of the functional elements (transport models) in the electrical lattice, using known or modeled (hypothesized) temperature dependence of electrical resistance, permittivity, and other electrical properties, such as nonlinear behavior such as in semiconductors.

In an alternative method of analysis, a plurality of lattices are solved simultaneously, or in parallel, without feedback or iteration. For example, an electrical lattice yields a distribution of power dissipation (as above), with each local (e.g., intranodal) power used as input to a corresponding node in a simultaneously solved thermal lattice. Presently the series (iterative) version is preferred.

The systems and methods of the invention are used to simulate a wide range of objects and physical systems. Several explicit examples are presented below. In more general terms, the range of objects and physical systems that can be simulated includes one or more biological specimens, dead or living, and can also include the interaction of biological specimens with devices such as electrodes, heaters, drug delivery devices, catheters, and other apparatus, as well as the interaction of biological specimens with chemicals and with physical phenomena such as electric, acoustic, gravitational or inertial fields.

Examples of biological systems at the cellular level include cells suspended in media such as phosphate buffered saline, growth media or culture media; cells such as fibroblasts cultured on solid surfaces such as glass or plastic, on porous media such as track-etched filters, or on gels and on porous polymeric materials; multicellular structures such as monolayers of cells with contacting cells with or without tight junctions, and models of solid tissue.

Typical passive parameters usefully employed at the cellular level include the electrical resistivity of a cell membrane, the dielectric constant of a cell membrane, and the electrical permittivity of a cell membrane. In addition, simulation can involve the electroporation threshold voltage, and models for recovery of electroporated cell membrane regions. Features that can be studied include the cell membrane permeability to specific molecules or ions, and the cell membrane partition coefficient for specific molecules or ions with respect to intra- and extracellular media. In addition, models can include thermal conductivity, specific heat and mass density of cell membranes, and of various intra- and extracellular media. Parameters useful in modeling media include electrical resistivity, and electrical permittivity of aqueous media such as saline, extracellular fluid, interstitial fluid, blood plasma, growth media, culture media, and the like.

Other modeling parameters include the resting transmembrane voltage or resting potential of a cell. The enzyme activity of a cell can be modeled using functional models such as the Michaelis-Menton kinetics model that involves two parameters, Vmax, the maximum reaction velocity, and Km, the Michaelis constant. The activity V is given in equation (1)

V=Vmax*c/[Km+c] (1)

where c is the local concentration at the site at which enzyme activity is assigned. For example, different values of Vmax can be assigned within a model.

Another area of simulation includes tissue of various types, including skin tissue, such as mammalian skin broadly, and human skin specifically. Skin tissue models include multicellular models of the stratum corneum, with or without models of the epidermis and other regions of the skin. Other systems that can be simulated include blood vessel walls with or without surrounding tissue, and blood, at normal or abnormal hematocrit levels.

Average properties, parameters and features of a tissue are used, such that each computational volume element (“voxel”) contains many cells. Typical parameters usefully employed at the tissue level include the mass density, electrical resistivity, electrical permittivity, thermal conductivity, specific heat, solubility, relative solubility, partition coefficient for a molecule and/or ion, diffusion coefficient for a molecule and/or ion, latent heat of condensation and evaporation, latent heat of freezing and melting, electroporation threshold for cells within a tissue voxel, perfusion, enzyme activity, and spontaneous inactivation rate for molecules within a tissue voxel. These parameters often depend on temperature, and pressure.

A valuable feature of lattice circuit simulations is that many different types of coupled processes and properties can be included within functional elements. For example, in some embodiments, the current through a particular functional element (transport model) can be dependent on linear or non-linear functions of voltages or currents anywhere in the simulation circuit. In some embodiments, nodes in the circuit can represent spatial locations in the physical system model, or can represent functions outside of the spatial extent of the physical system. A clock function is an example of a part of a circuit which is outside of the spatial lattice. Simulation of an abrupt phase transition is done with voltage controlled switches. As described further in Example 1 below, the electroporation of a cell membrane is an abrupt lowering of membrane resistance accomplished with a transmembrane voltage dependent switch.

The use of switches allows abrupt, electroporation-based cell membrane resistance change to be included in functional elements that represent charge transport through an elementary region of a cell membrane. Examples of abrupt phase transition behavior, for example behavior associated with melting/freezing, dissolution/crystallization and evaporation/condensation, can be based on functional elements that comprise at least one voltage dependent switch. In other embodiments, functional elements comprise current dependent switches. In some embodiments, switches can have different thresholds for closing and for opening, thereby providing the basis of hysterisis in a functional element.

As described further in Example 11 below, the diffusion coefficient or the partition coefficient of regions of the physical system model can depend on the chemical potential of a molecule diffusing into and within the physical system model. In one embodiment, this is accomplished by assigning resistors with nonlinear voltage dependence to represent diffusion coefficients that depend on chemical potential as functional elements. In other embodiments, capacitors with nonlinear voltage dependence can represent partition coefficients that depend on chemical potential.

In some embodiments, parameters within functional elements can also be changed by voltages or currents or charges on control processes that operate as part of the model, but reside outside the volume represented by the lattice circuit. For example, a clock control function can be provided by creating a current ramp or voltage ramp that is connected to the lattice circuit, but the clock is not located within the volume of the physical system model.

In this example, the clock output voltage can be provided to at least one functional element within the lattice circuit, such that said functional element changes for some range of values of the clock voltage. As described in greater detail in Example 14 below, several voltage-sensitive switches with different assigned switching thresholds are used to change conditions when a threshold voltage corresponding to one of the switches is reached, creating different functional elements that are changed at different times. Although the examples shown are constructed using resistors, capacitors and switches, those of skill in the electrical engineering arts will recognize that other circuit elements, such as inductors, can be used in building lattice circuit models.

### EXAMPLE 1

### Fibroblast Electroporation

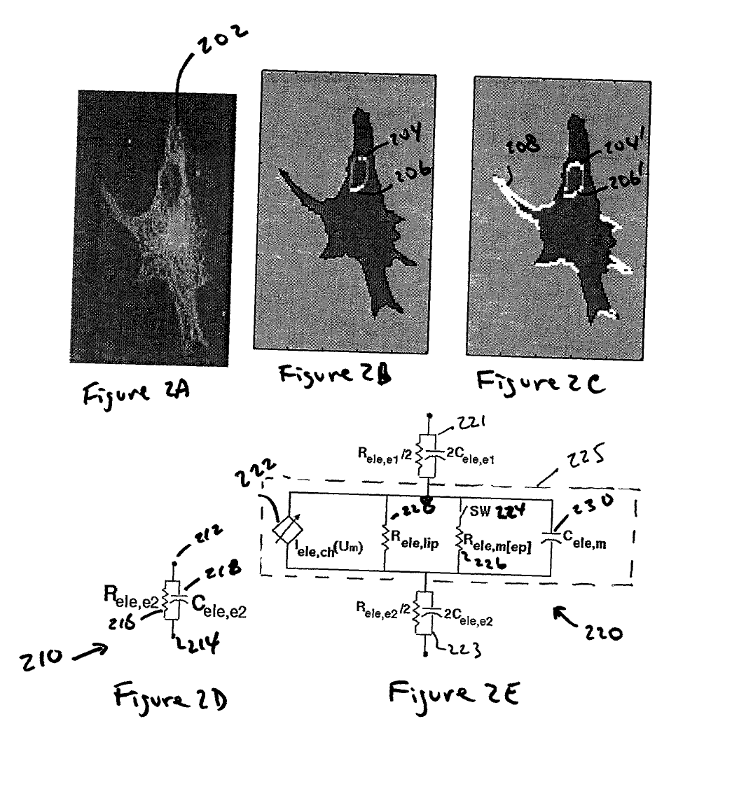

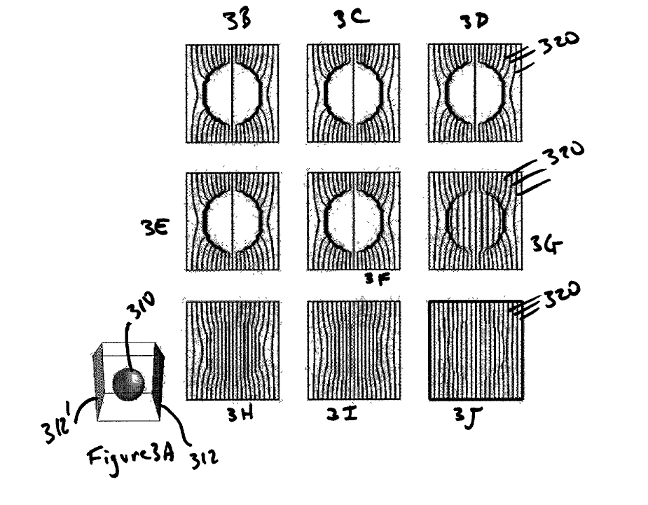

FIGS. 2A-2C depict the modeling of the electroporation of intracellular entities in a cell with a complicated shape. FIG. 2A is an electron microscopy image of a fibroblast 202. A two-dimensional model of a fibroblast was created from a fluorescence microscopy image as a 100 node×150 node lattice with elementary cubic regions with sides equal to the intemodal spacing of 0.1 μm. Both the plasma membrane and nuclear membrane were represented by a bilayer membrane containing a simple threshold-model of electroporation. The electrical resistivity of the intracellular medium was three times that of the extracellular medium.

The electrical circuit model is depicted in FIGS. 2D and 2E. FIG. 2D shows an illustrative electrolyte functional element 210 between adjacent nodes 212, 214, comprising a resistor 216 and a capacitor 218. The electrolyte regions were represented by the electrolyte functional element. FIG. 2E shows an illustrative model of membrane segments represented by a membrane-electrolyte interface transport model 220. The membrane-electrolyte interface transport model 220 has three sections, a first section 221 representing a first electrolyte, a second section 223 representing a second electrolyte, and a third section 225 representing the cell membrane, with the cell membrane transport model 225 having four charge transport models. The first charge transport model involves combined contributions of all channels and the intra/extracellular ion gradients that generate the cell resting potential, and a membrane resistance with a sigmoidal voltage dependence. Both are represented by a voltage-sensitive current source, I_ele,ch(Um) 222, obtained from a fit of whole cell experimental data, as reported in J. Exp. Biol. 196:263, 1994. The second charge transport model, electroporation is represented by a simple model involving an abrupt, irreversible transition denoted by SW 224, a hysteretic, voltage-sensitive switch that closes, and remains closed, if the selected electroporation threshold transmembrane voltage is reached. The transition is from an open circuit to a high conductance state denoted by R_ele,m[ep]=4.2×10⁶ Ohm (ω) 226, consistent with maximum permeabilization of 0.1 % fractional aqueous area associated with electroporation. The third charge transport model is a fixed high resistance R_ele,lip=6×10¹¹ ω 228 of the membrane lipids. The fourth charge transport model is a fixed membrane capacitance, C_ele,m=1.6×10⁻¹⁵ F 230. The nuclear membrane was assigned an electroporation threshold of 400 mV, and the plasma membrane was assigned 1000 mV. The polarity of the current and voltage sources within the functional elements were determined from the orientation of the element with respect to a reference axis.

The electric field was applied between the top and bottom boundaries as an ultrashort pulse of 5 ns width. Two regions of nuclear membrane 204, 206 are electroporated (shown in white) when the pulse magnitude is 12 kV/cm (FIG. 2B). The same ultrashort pulse but with a larger magnitude of 30 kV/cm, causes more extensive electroporation in both the plasma membrane 208 and the nuclear membrane 204′, 206′ (FIG. 2C).

### EXAMPLE 2

### Red Blood Cell Ghost Subjected to Sinusoidal Electric Fields with Parallel Plane Electrodes

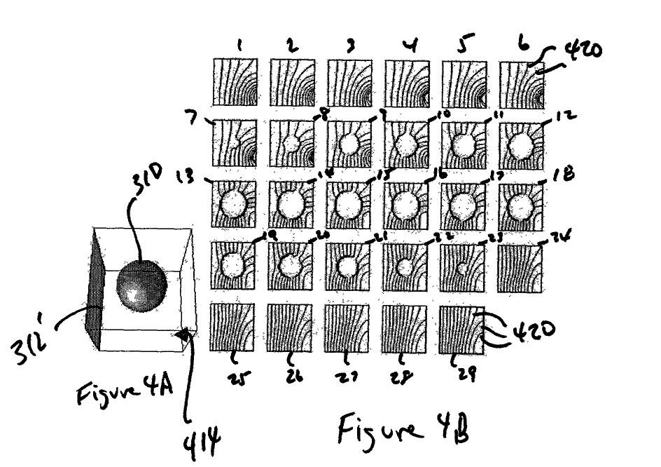

FIG. 3A shows a perspective drawing of a spherical cell 310 confined within parallel plane electrodes 312, 312′ in a physiologic fluid. The model treats the small field electric field distribution for a spherical cell model of a red blood cell ghost that is confined to a cubic volume and surrounded by physiologic saline. In FIG. 3A, the left and right walls of the cubic volume are planar conductive electrodes 312, 312′ (dark gray), for example made of metal. The other four walls of the simulation region are electrically insulating. A discrete version of a spherical cell (10 μm diameter) in a conducting medium was created as a 29×29×29 lattice with an intemodal spacing of 0.625 μm. The equation for a sphere determined the intranodal sites which were assigned a functional element for the interface of both an extracellular and intracellular electrolyte with the cell membrane. A circuit as given in FIGS. 2D and 2E was used. A membrane resistivity of 10⁸ ω m was used to approximate the classic, insulating membrane. Intra and extracellular resistivities were 0.7 ω m, and 2.8 ω m. The resulting lattice was solved for the case of an uniform applied field (1 mV between electrodes) using two parallel electrodes as shown in FIG. 3A. The equipotentials, generally 320, for a central slice of the cubic simulation region is shown for different frequencies in decades from 10 Hz to 1 GHz in FIGS. 3B through 3J, respectively.

### EXAMPLE 3

### Red Blood Cell Ghost Subjected to Sinusoidal Electric Fields with Point Electrode

This three-dimensional example solves a more complicated problem than that of Example 2. One planar electrode 312 of Example 2 is replaced with a sharp pointed electrode 414, creating electric fields with appreciable spatial inhomogeneity. FIG. 4A is a perspective drawing of a spherical cell enclosed within a planar electrode and a small pointed microelectrode. FIGS. 4B(1)-4B(29) are illustrative equipotentials, generally 420, along plane surfaces running perpendicular to the plane electrodes symmetrically on either side of the central slice through the simulation geometry.

In this Example, low field electric field distributions for a spherical cell (e.g., a model of a red blood cell ghost) are stimulated by a sharp microelectrode. Once again, the red blood cell ghost that is confined to a cubic volume and surrounded by physiologic saline. As shown in FIG. 4A, the left wall of the cubic volume is a planar conductive electrode 312′ (dark gray), and the right, opposite wall in electrically insulating except for a small pointed microelectrode 414 (dark gray). A discrete version of a spherical cell (10 μm diameter) in a conducting medium was created as a 29×29×29 lattice with an internodal spacing of 0.625 μm. The equation for a sphere determined the intranodal sites which were assigned a functional element for the interface of both an extracellular and intracellular electrolyte with the cell membrane, again using the circuits of FIGS. 2D and 2E. A membrane resistivity of 10⁸ ω m was used to approximate the classic, insulating membrane. Intra and extracellular electrolyte resistivities were 0.7 ω m, and 2.8 ω m. The electrolyte and membrane models were assigned to lattice elements corresponding to the three-dimensional geometry. The resulting lattice was solved for the case of a small applied field (1 mV between electrodes) using a parallel electrode and a sharp, pointed microelectrode, as shown in FIG. 4A. In FIGS. 4B(1)-4B(29), the equipotentials are shown for slices running symmetrically perpendicular to the plane electrode on either side of the central slice through the simulation geometry.

### EXAMPLE 4

### Current Clamped Axon with Propagation Action Potential

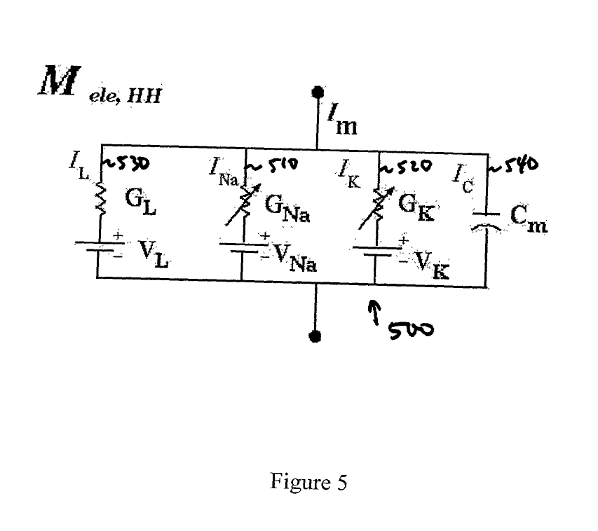

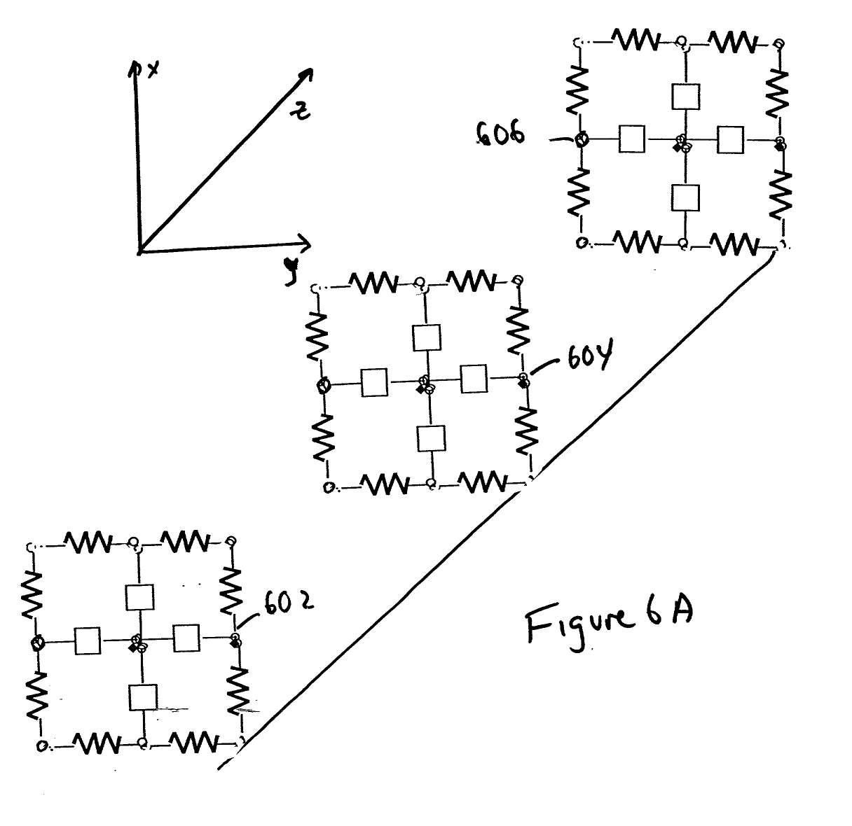

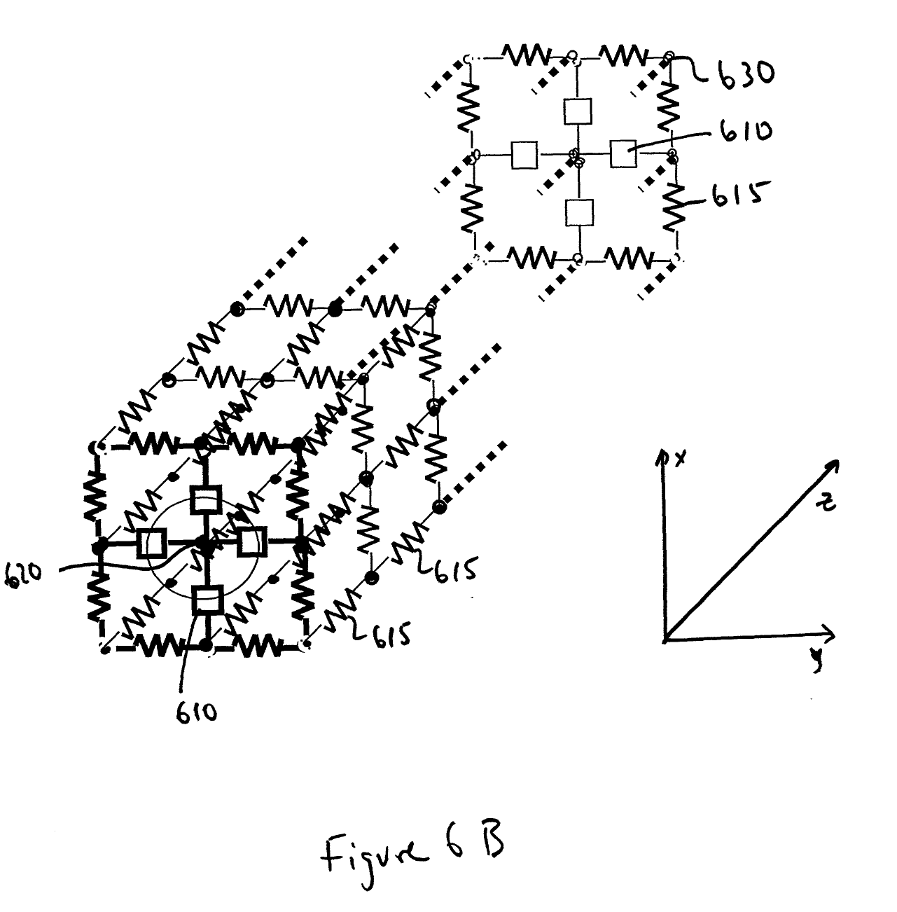

This three-dimensional example shows stimulation of a nerve with one electrode inserted inside the nerve and the other electrode on the outside. This model is the basis of a current clamp stimulation. The axon is simulated in a 3×3×200 lattice along the axis of a non-myelinated axon. The axon membrane is modeled on the Hodgkin-Huxley squid giant axon equivalent circuit shown in FIG. 5.

In FIG. 5, the membrane element 500 has the Hodgkin-Huxley Sodium (I_{Na}=a□G_{Na□}□m³□h(Vₘ−V_{Na})) ion channel 510, the Potasium (I_{K}=a□G_{K□}□n⁴(Vₘ−V_{K})) ion channel 520, a leakage current (I_{L}=a□G_{L□}(Vₘ−V_{L})) 530, and a membrane displacement current (I_{C}=a□C_{m□}□□dVₘ/dt) 540. Standard values for the conductivities and resting potentials are: G_{Na□}=120 mS/cm², G_{K□}=36 mS/cm², G_{L□}=0.3 mS/cm², V_{Na}=55 mV, V_{K}=−72 mV, V_{L}=−49 mV, and C_{m□}=1□F/cm². The Hodgkin-Huxley differential equations for the activation parameters n, m, and h are given by Weiss T. F., “Cell Biophysics”, MIT Press, Cambridge, Mass., 1996. The currents scale with the elemental membrane area a=10⁻⁹ m².

FIG. 6A is an exploded view of three two dimensional lattice circuits 602, 604, 606. The three dimensional lattice circuit model is constructed by connecting corresponding nodes in adjacent two dimensional lattice circuits with resistors 615, as shown schematically in FIG. 6B. Three mutually perpendicular axes (x, y, and z) are shown to define the directions along which the lattice circuit is constructed.

FIG. 6B is a perspective drawing of an illustrative three dimensional lattice circuit used to model the current clamped axon. The lattice spacing is 10 μm×10 μm×100 μm which corresponds to a simulation volume of 30 μm×30 μm×20 μm. Between each node is a resistor 615 (R=0.7 ω m) for electrolyte regions, or a membrane element shown as a box 610 in FIG. 6B. The current clamp electrodes are located at the center node 620 at z=0 at one end of axon, and at the node 630 at the upper right corner at z=20 mm. The current is 20 nA from node 630 to node 620.

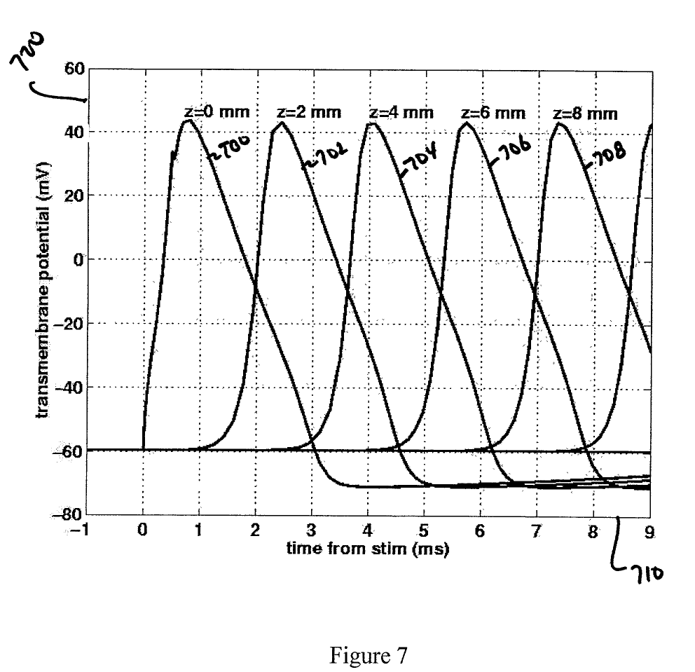

FIG. 7 shows the results of an illustrative simulation as a plot of the transmembrane potential (Um) as a function of time. Several sections 700, 702, 704, 706, 708 along the axon axis are plotted and labeled at the waveform peak. In a current clamp, the stimulus is a current across the axon membrane (one electrode inside the axon and the other outside). The stimulus starts at t=0 and ends at t=0.5 ms. The propagating action potential, seen here as a transmembrane potential wave, is triggered by the stimulus and travels down the length of the axon. The action potential rises to a peak voltage of 40 mV before returning to a resting potential of −59 mV. In FIG. 7, time is plotted along the horizontal axis 710, and amplitude is plotted along the vertical axis 720.

### EXAMPLE 5

### Axon with External Electrodes

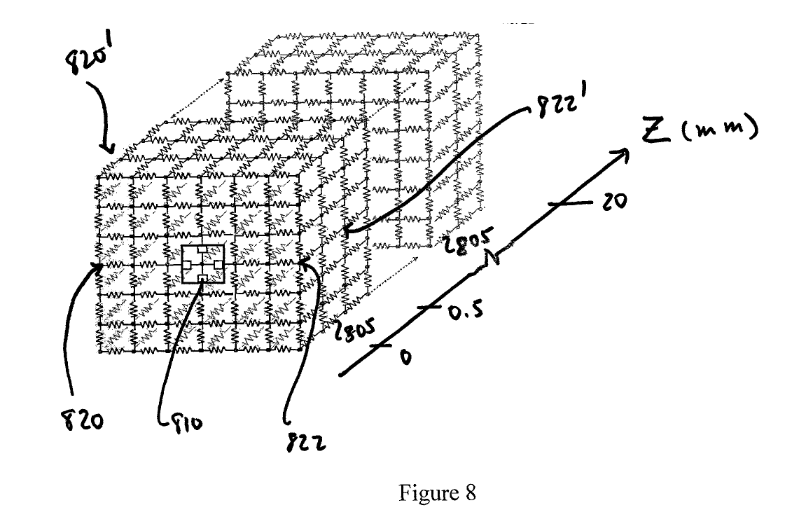

This three-dimensional example shows stimulation of a nerve using two external electrodes. Propagation of action potentials in response to an external electric field of a single axon is difficult to simulate in one or two dimensions since the regions inside and outside the axon are described in three dimensions. The axon membrane is modeled on the Hodgkin-Huxley (HH) squid giant axon equivalent circuit shown in FIG. 5, with parameters as given above. M_{ele,HH} is a label for the elemental HH transport model. In this simulation, electrodes were placed above and below the axon and pulsed with a range of voltages. As shown in FIG. 8, the axon is simulated in a 7×7×100 lattice along the axis of a non-myelinated axon. The axon membrane surrounds a single line of nodes on the axis. Electrolyte is present along the internal nodes and outside the axon. The electrical properties of the electrolyte are modeled by resistors 805 between nodes determined by the resistivity of saline (0.7 ω-m). The lattice spacing is 10 μm×10 μm×100 μm which corresponds to a simulation volume of 70 μm×70 μm×10 mm. A resistor is placed between each node for electrolyte regions. Where membranes are present, a membrane element 810 is placed in the circuit, as shown as a box in FIG. 8.

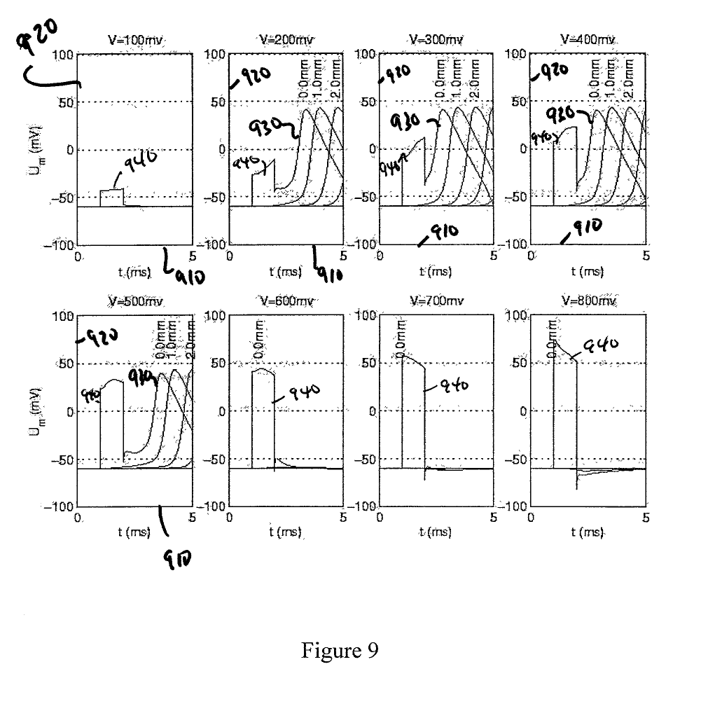

FIG. 9 shows the results of a simulation of an axon exposed to an external field. FIG. 9 shows the results of the simulation as the transmembrane potential (Uₘ) as a function of time for eight values of voltage, i.e., 100 mV through 800 mV, in 100 mV steps, applied across the external electrodes. Time is plotted along the horizontal axis 910, and response voltages in millivolts are plotted along the vertical axis 920. Several sections along the axon axis are plotted and labeled with the distance along the axis at the respective waveform peak. The stimulus starts at t=1 ms and ends at t=2 ms. The field is generated by current between an electrode at the node 820 at z=0 and an electrode at the node 822 at z=0 of FIG. 8. The propagating action potential 930, seen here as a transmembrane potential wave, is triggered by the stimulus and travels down the length of the axon. The action potential 930 rises to a peak voltage of 40 mV before returning to a resting potential of −59 mV. The pulse 940 at 1-2 ms is the excitation that leads to the action potential.

As is shown in FIG. 9, an action potential 930 is generated by an external field stimulus exceeding 100 mV but less than 600 mV. The lower threshold is consistent with HH axon membrane simulations in 1 or 2 dimensions, but the lack of an action potential at higher amplitude is a consequence of the external field in a full three dimensional axon simulation.

### EXAMPLE 6

### Damaged Axon with Action Potential Quenching

This three-dimensional example shows successful stimulation of a nerve with external electrodes, but downstream quenching due to low membrane resistance that represents damage or temporary changes due to electroporation of a portion of the nerve. Here again, the model uses the circuit of FIG. 5 and the axon model presented in FIG. 8.

The lattice spacing is 10 μm×10 μm×50 μm which corresponds to a simulation volume of 70 μm×70 μm×5 mm. The axon runs down the center of the region, with axon membrane 810 surrounding the central line of nodes. The central line of nodes and the nodes outside of the axon represent intracelluar and extracellular electrolyte. Between each electrolyte node is a resistance determined by the resistivity of saline (0.7 ohm-m).

Axon membrane elements have the Hodgkin-Huxley model for Sodium and Potasium ion channels, leakage current, and a membrane displacement current with standard values for the conductivities and resting potentials, as described earlier in conjunction with FIG. 5. At z=2.5 mm and beyond (e.g., further away from the stimulation site), the axon membrane is damaged by increased membrane conductivity. The increase in conductivity is consistent with the formation of pores in the membrane that are filled with electrolyte. The membrane conductivity in the damaged region (i.e., z greater than 2.5 mm) is varied over factors of 1 (no damage) to 0.0001 (fully electroporated).

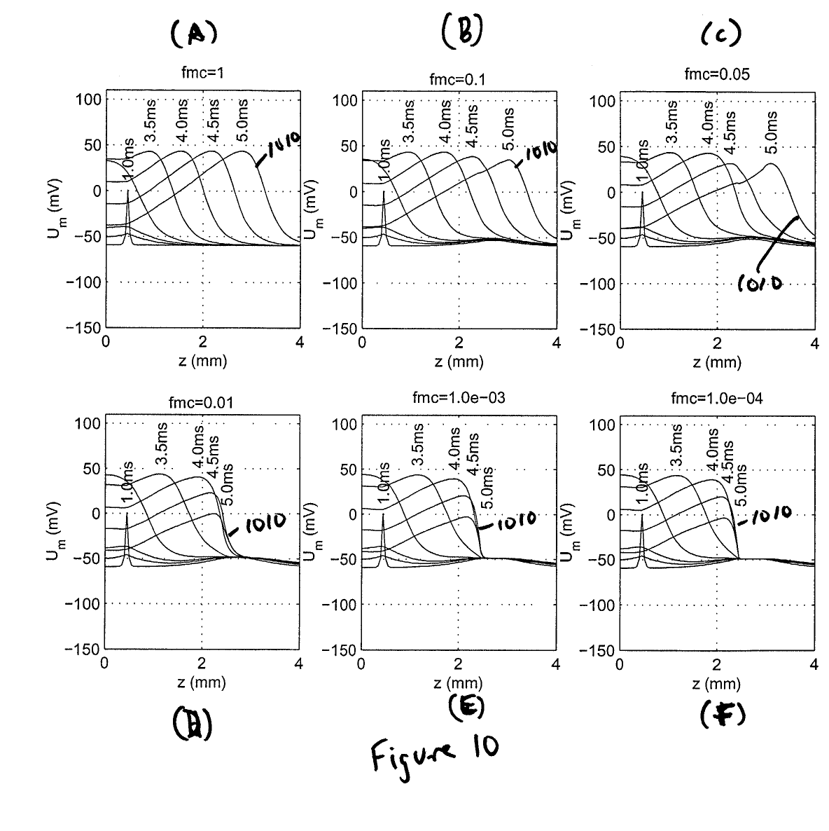

FIGS. 10A through FIG. 10F show plots of the transmembrane potential 1010 (Um) as a function of distance along the axon, for different fractional changes in membrane conductivity (fmc) in the range 1 to 10⁻⁴. Several time slices are plotted and labeled near the waveform peaks. The action potential is the axon membrane response to a electric field pulse across the axon at z=0. The stimulus amplitude is 0.4V across the electrodes, which corresponds to an average E field of 5.7 V/m across the region around z=0. The stimulus is applied between two nodes having coordinates given by (x, y, z)=(+35 μm, 0 μm, 0.5 mm) (820′ in FIG. 8) and (−35 μm, 0 μm, 0.5 mm) (822′ in FIG. 8). The region of damage is the entire membrane area over the length of 0.5 mm, starting at z=2.5 mm and ending at z=3.0 mm. This involved assigning a small shunting resistance across the HH functional elements for all the transmembrane nodes over the distance of 10 nodes in the z direction. The stimulus starts at t=1 ms and ends at t=2 ms. The propagating action potential, seen here as a transmembrane potential wave 1010, is triggered by the stimulus and travels down the length of the axon. The action potential 1010 rises to a peak voltage of 40 mV before returning to a resting potential of-59 mV. Each panel (A through F) is labeled with the fractional change in membrane conductivity (fmc) in the damaged region. The action potential 1010 is attenuated at z=2.5 mm when the membrane conductivity is lowered by a factor of 0.05, and completely quenched at z=2.5 mm and beyond when the conductivity factor falls below 0.01.

### EXAMPLE 7

### Two Axons of Different Sizes

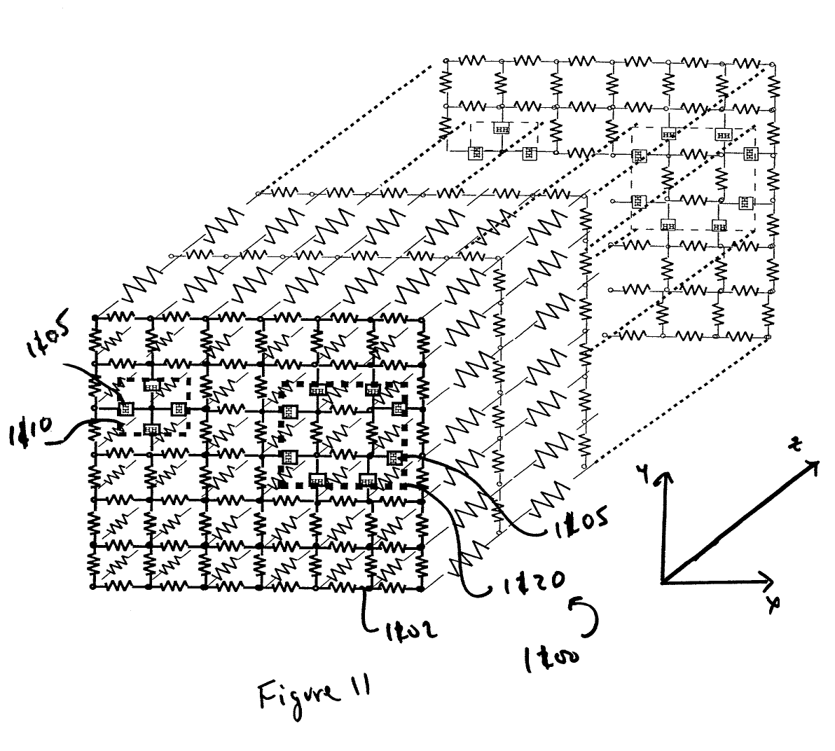

This three-dimensional example shows that a larger cross-section nerve can be stimulated without stimulating a nearby nerve with a smaller cross-section, with both nerves exposed to approximately the same magnitude electric field pulse provided by two external electrodes. FIG. 11 shows an illustrative model, in which two axons are modeled within a 70 μm×70 μm×2.5 mm volume. The axons are both exposed to an electric field stimulus across the volume, and the resulting action potentials, or lack of action potentials, are analyzed. The volume is segmented into a lattice of 7×7×25 nodes along the x, y, and z axes, respectively, where the length of the axons runs along the z axis. One of the axons has a small cross section 1110, shown in dotted outline on the front surface 1102 of model 1100, of one line of nodes inside the axon membrane. The membrane is model comprises four HH circuits 1105. The other axon has a larger cross section 1120, shown in dotted outline on the front surface 1102 of model 1100, comprising four lines of nodes inside the axon membrane, and having 8 HH membrane elements 1105. The external electrodes are located at x=+35 μm and −35 μm (positive and negative voltage, respectively), at −35 μm<y<+35 μm (all nodes among the upper and lower nodes in y), and at −50 μm<z<50 μm (one layer of nodes in z).

The nodes are linked by two types of functional elements, a purely resistive element that models electrolyte inside and outside the membrane, and the axon membrane element, which is described by the Hodgkin-Huxley (HH) model. A circuit diagram for the HH model is shown in FIG. 5 The resistivity of the electrolyte is 0.7 ω-m. The HH model is based on the properties of the squid giant axon.

The lattice geometry is shown in FIG. 11. The lattice spacing is 10 μm in the x and y dimensions and 100 μm in the z direction along the axon axis. The axon membrane is denoted by boxes 1105 surrounding the axon interior regions. The cross section of the axons are also marked by dashed boxes, the small axon 1110 on the left and the large axon 1120 on the right. The stimulus across the volume is located at z=0. The line of nodes along the top and bottom of the lattice at z=0 are the stimulation electrodes. The stimulus is a voltage pulse that begins at 1 ms and ends at 2 ms into the simulation. The simulation itself ends at 5 ms.

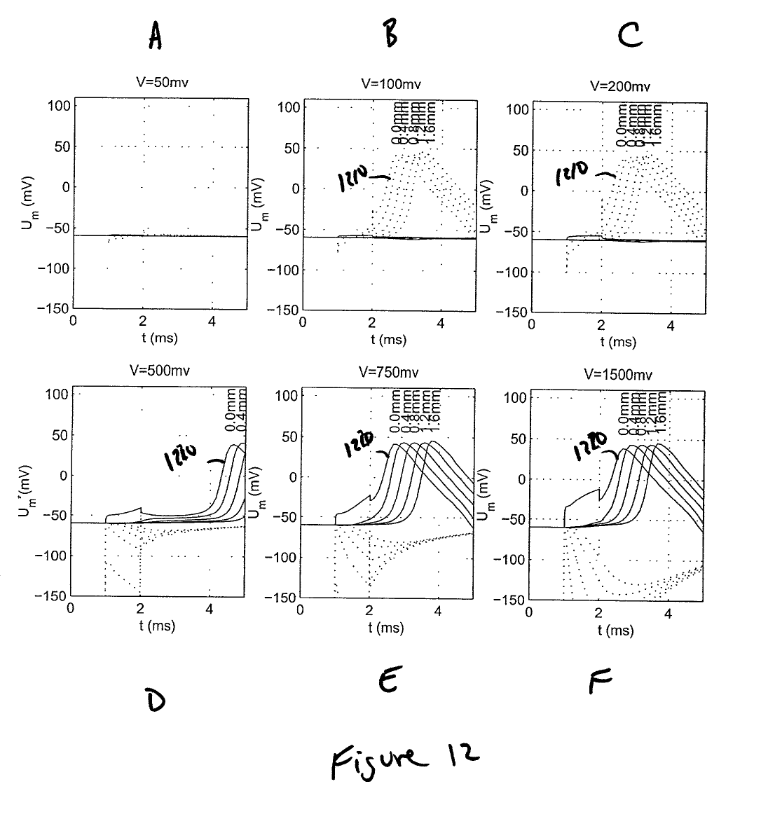

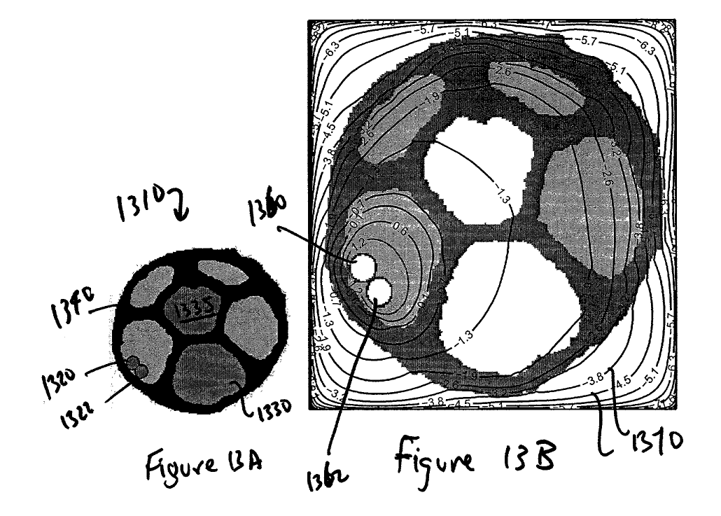

The circuit response is simulated in SPICE, which calculates the voltage at each node as function of time. FIGS. 12A through 12F show plots of the transmembrane potential 1210, 1220 (Um) for different stimulation potentials in the range of 50 mV to 1500 mV. The large axon response is given by dotted lines and the small axon response is given by solid lines. the responses appear as functions of time for all sections along the z direction. A propagating action potential appears as a wave that is triggered by the stimulus and propagates away. At t=0, the transmembrane potential is the “resting potential” (−59 mV). The stimulus causes a perturbation away from the resting potential and can result in action potentials on one, both, or neither of the axons.

Each panel of FIGS. 12A through 12F is labeled with the stimulus amplitude. As shown in FIG. 12A, at low amplitude (50 mV) there is no action potential. As the amplitude is increased to 100 mV (FIG. 12B), the large axon begins to respond with an action potential 1210. The series of dotted lines show the action potential 1210 waveform as it travels away from the stimulus to the end of the simulation region. The position along the axon relative to the stimulus is labeled above the peaks of the action potential 1210 waves. As shown in FIG. 12D, the stimulus amplitude is further increased to 500 mV, the large axon's action potential is quenched, and the small axon (solid lines) begins to show an action potential 1220. Above 500 mV, the small axon shows a clear action potential 1220, while the larger axon does not.

### EXAMPLE 8

### Temperature Distribution in Catheter Surrounded by Blood

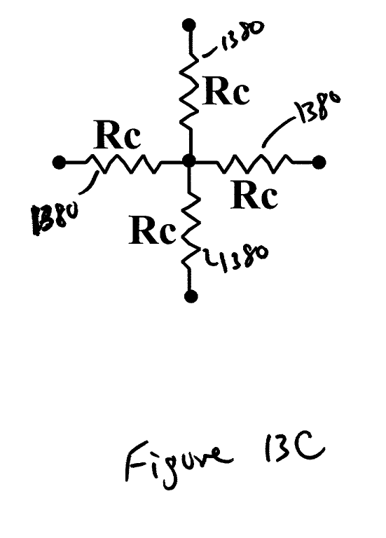

FIG. 13A shows an illustrative model of an electrically heated catheter 1310 within a lumen filled with fluid, namely blood. FIG. 13B shows the temperature distribution and some isotherms obtained from solving the model of FIG. 13A. The biological system model was constructed from an image. A real, commercially available catheter with two copper wires 1320, 1322 embedded within one of its ports was cut into two pieces. The end of catheter piece was placed on a flatbed scanner. The cross-section of the catheter was scanned and stored as a bitmap image, as shown in FIG. 13A. A two-dimensional model of the geometry was created from the bitmap image. The two circular regions 1320, 1322 at the bottom left are the copper wires. The two darker gray regions 1330, 1335 represent the ports containing electrolytes. The remaining four ports transport gases having small thermal conductivity. The black surrounding region 1340 represents the plastic walls of the catheter. The approximate diameter of the nearly circular catheter was about 2.5 mm.

The simulation geometry was made up of 258 nodes×261 nodes with an internodal spacing of 10 μm. The geometry of the biological system model was then assigned local transport models (i.e., functional elements) to describe steady state heat conduction. Specifically, thermal resistances were assigned to the various regions within the catheter cross-section, with each thermal resistance being the reciprocal of the thermal conductivity multiplied by the internodal spacing. This thermal resistance network or thermal resistance lattice was then represented by an equivalent electrical resistance lattice circuit shown in FIG. 13C. The resistors R_{c} 1380 represent the thermal resistance of materials with different thermal conductivities. These local transport models (thermal resistances or thermal resistors) were assigned to image regions of different shades of gray, an assignment process which can be made easy to learn and use, for example by using a “click and drag” process. Thermal conductivity of copper, water, air, blood, and polyurethane substrate were 0.2 W/mm ° C., 6.23×10⁻⁴ W/mm ° C., 2.7×10⁻⁵ W/mm ° C., 0.2 W/mm ° C., and 1.5×10⁻⁴ W/mm ° C., respectively.

The copper wires 1360, 1362 comprise two proximate heat sources powered by a current flowing through them, and having electrical power dissipation of 0.0041 W/mm³. The resulting steady-state temperature distribution is shown in FIG. 13B on the right as isotherms 1370. The isotherms are shown in logarithmic scale as increases in temperature over the surrounding blood temperature of 37° C.

### EXAMPLE 9

### Time Sequence of Skeletal Muscle Electroporation

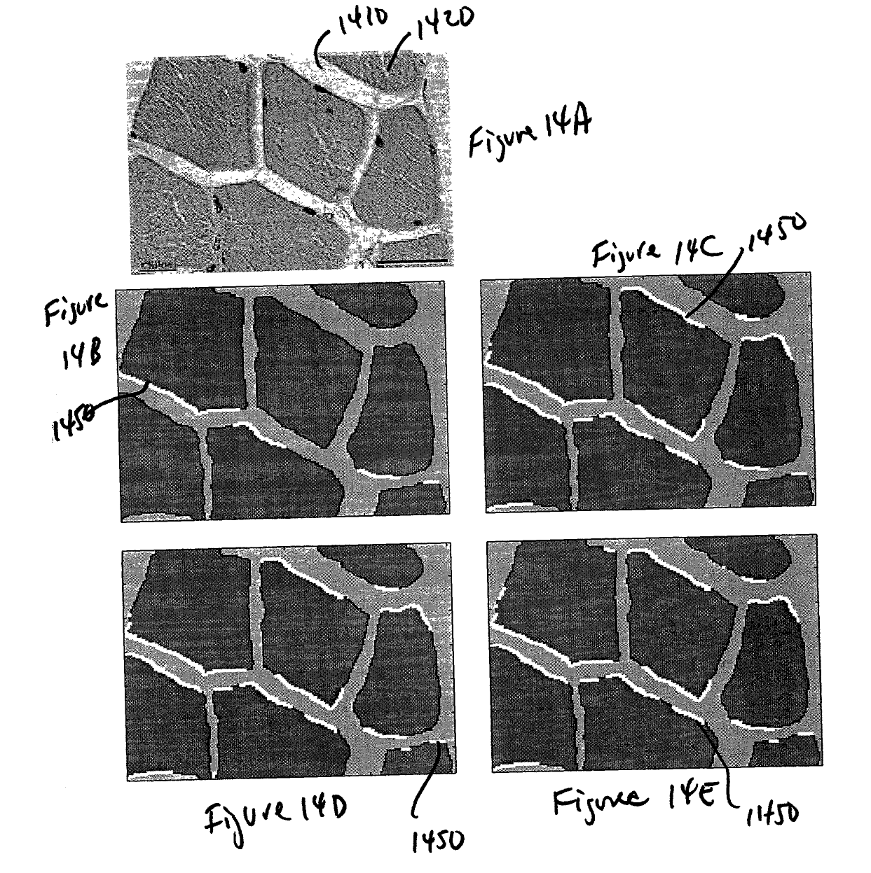

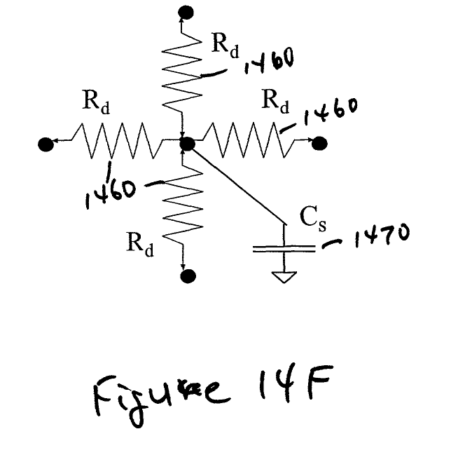

FIG. 14A is a histological image of a specimen of skeletal muscle tissue. A two-dimensional model of a skeletal muscle tissue was created from the histological image as a 202 nodes×135 nodes with an internodal spacing of 0.4 μm. The plasma membrane 1410 was assigned a simple threshold model of electroporation. The intracellular medium 1420 resistivity was three times that of the extracellular resistivity.

The bulk electrolyte regions were represented by the electrolyte transport model as functional elements between adjacent nodes. The membrane segments, where the elementary membrane volumes were taken equal to the intranodal spacing cubed, were assigned a transport model for the extra- and intra-cellular electrolyte interface with the cell membrane. The membrane-electrolyte interface transport model has four charge transport models, which have been described with regard to FIG. 2E above.

The cell membrane was assigned an electroporation threshold of 1000 mV. The side boundaries of the simulation region were electrically insulating, represented by nodes which had three connections, as no connection existed to the region outside the simulation region. The field was applied between ideal planar electrodes at the top and bottom boundaries as pulses of 5 μs width with a delay of 1 μs in the beginning and a 1 μs rise time. FIGS. 14B through 14E show an illustrative time sequence of electroporation of a skeletal muscle tissue model system. The state of the tissue at different time points during the pulse (1.81, 1.99, 2.01, and 2.57 μs) are shown in the four panels 14B, 14C, 14D and 14E, respectively. The electroporated regions 1450 of the membrane are shown as white regions.

FIG. 14F is an illustrative lattice circuit used to model the skeletal muscle tissue system. In FIG. 14F, R_{d} 1460 is an electrical resistance that represents a diffusion coefficient for a drug molecule. Cₛ 1470 is an electrical capacitance to ground, representing storage by dissolution within an elementary volume (the internodal spacing cubed).

### EXAMPLE 10

### Temperature Distribution and Perfusion

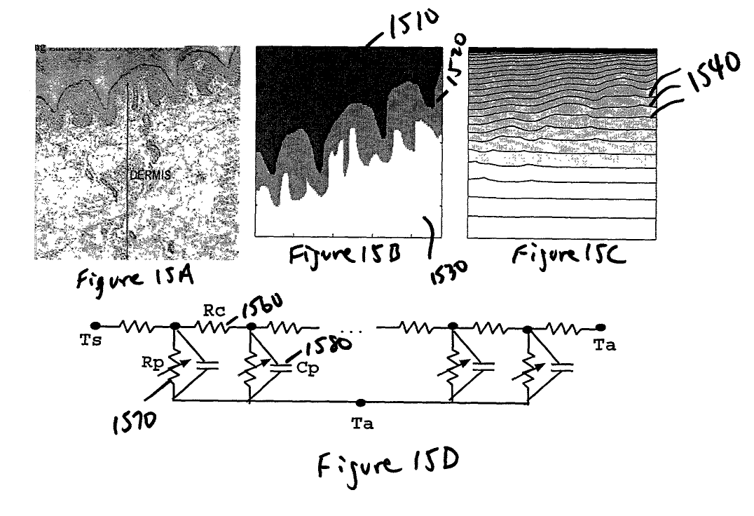

FIG. 15A is a histological image of a specimen of skin. FIG. 15B is an illustrative model including heat conduction and also and temperature-dependent perfusion, with perfusion regarded as transporting heat to a reference temperature, as in the Pennes bioheat equation (see reference below). The model was created from the image shown in FIG. 15A by superimposing the image on a 238 node×119 node lattice with an internodal spacing of 1 μm. The dark region 1510 represents the stratum corneum and epidermis regions that are unperfused.

In this model, the gray region 1520 represents the part of dermis that contains capillaries and was assigned perfusion that is temperature-dependent. The white region 1530 represents the remaining part of dermis that was assigned constant perfusion.

FIG. 15C is a temperature distribution deduced for the illustrative model shown in FIG. 15B. The results show isotherms 1540 for a fixed temperature difference between the t top surface temperature (Ts=42° C.) and the bottom (Ta=37° C., arterial blood reference temperature) boundaries. The spatial distribution of the temperature field in a biological medium is governed by a heat balance among heat conduction, and convection into and out of the tissue medium. The heat balance assumes that blood flow within the tissue is nondirectional at the capillary level. With these assumptions and ignoring the metabolic heat generation, the temperature distribution, T, is described by Pennes bioheat equation, which was recently reviewed in J. Appl. Physiol. 85:35-41, 1998.

FIG. 15D is a schematic diagram of an equivalent circuit used to model the skin, including the effects of heat conduction and of temperature-dependent perfusion. In the lattice circuit voltage corresponds to the temperature difference compared to a reference temperature of 37 C, so that electrical ground of the lattice circuit corresponds to 37 C. The temperature distribution was solved using the equivalent circuit with the indicated functional elements (transport models) linking adjacent nodes, or linking nodes to a reference temperature (Tₐ). as shown above. The heat conduction between adjacent nodes is represented by a resistor, R_{c}, 1560. The contribution of perfusion to heat removal is modeled using the voltage-dependent resistor Rₚ 1570 that represents temperature-dependent perfusion so as to account for temperature dependent perfusion. The capacitor Cₚ 1580 represents heat capacity. The model defines the relations

R_{c}=(1/k)(Dx/(Dy*Dz))

Rₚ=1/[(Dx*Dy*Dz)(omega_{b}*c_{b}*rho_{b}*rho)]

Cₚ=(Dx*Dy*Dz)*c_{b}*rho_{b}

where

Dx, Dy, Dz are the lattice element dimensions,

rho and c are the density and specific heat of the tissue,

rho_{b} and c_{b} are the density and specific heat of blood, and

k is the thermal conductivity of the tissue.

The temperature dependent perfusion is modeled by a variable perfusion rate given by: omega_{b} (T)=omega₀+alpha_{omega} (T−Tₐ) where omega₀=100 ml/100 g-min. The following parameters were used in the simulation.

Dx=Dy=Dz=1 μm;

k_sc=0.1 W/m ° C.;

k_epi=0.2 W/m ° C.;

c_{b}=4175 J/Kg ° C.;

rho=rho_{b}=1000 Kg/m³;

omega=0.25.

### EXAMPLE 11

### Diffusive Permeation with Enhancer

This two-dimensional example shows diffusive molecular transport in which the diffusion coefficient and/or the partition coefficient depend on the local chemical potential of the diffusing chemical species.

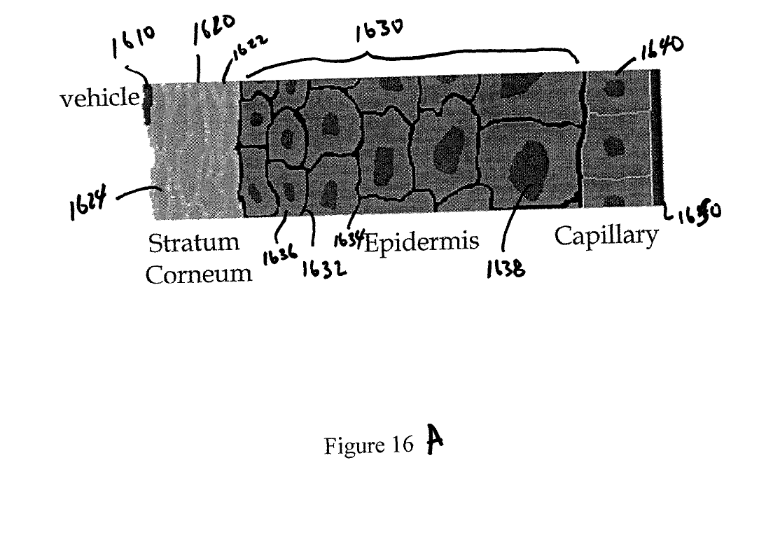

The delivery of drugs through tissue is a diffusion process that is described by the time dependent diffusion equation 2 (Ficke's second law):

$$\frac{\partial q}{\partial t} = ∇ \cdot ( D ∇ q ) \qquad ( 2 )$$

where q is the drug concentration and D is the tissue diffusion coefficient. In heterogeneous tissue the solution to the diffusion equation is greatly complicated by the assignment of diffusion coefficients and corresponding boundary conditions. An additional complication is the effect of chemical enhancers that change the effective diffusion coefficient as the drug concentration changes. The method of lattice circuits is well suited for this problem. A cross sectional drawing of the skin is shown in FIG. 16A. The different tissue types are marked in different shades of gray. The supplied drug is provided in the dose “vehicle” 1610 is the dark region on the upper left. The Stratum Corneum (SC) 1620 comprises lipid regions 1622 (light gray) encasing corneocytes 1624 (medium gray). The epidermis 1630 is separated in cells by bilipid membrane 1632 between the extracellular electrolyte 1634 (black) and intracellular electrolyte 1636 (medium gray). The cell nuclei 1638 are darker gray. Tight junctions join the layer of cells 1640 on the right and the capillary 1650 is at the far right.

FIG. 16B is an illustrative circuit segment used to model skin. In the circuit of FIG. 16B, R_{d} 1662 is an electrical resistance that depends on voltage, representing a diffusion coefficient that depends on chemical potential. In the circuit of FIG. 16B, C_{S} is an electrical capacitance that depends on voltage, representing a diffusion coefficient that depends on chemical potential. In the circuit of FIG. 16B, R_{MM} is an electrical resistance to a reference node (electrical ground) and that has a nonlinear dependence on voltage to represent the enzyme activity described by Michaelis-Menton kinetics as described above in equation (1), where voltage represents molecule concentration.

The 100 node×384 node lattice used to model the skin has a lattice spacing of 0.25 μm, and represents a simulation volume of 99×384×1×0.253³ μm³, or 6,067 μm³. In the lattice circuit voltage represents chemical potential. The diffusion coefficient in aqueous regions is 2×10⁻¹¹ m²/s. In the lipid regions, the diffusion coefficient is 10⁻¹¹ m²/s at zero drug chemical potential and saturates at 2×10⁻¹¹ m²/s at high drug chemical potential. The changing diffusion coefficient in lipid is the effect of the drug enhancer. The partition coefficient of drug into lipid relative to water is 0.1.

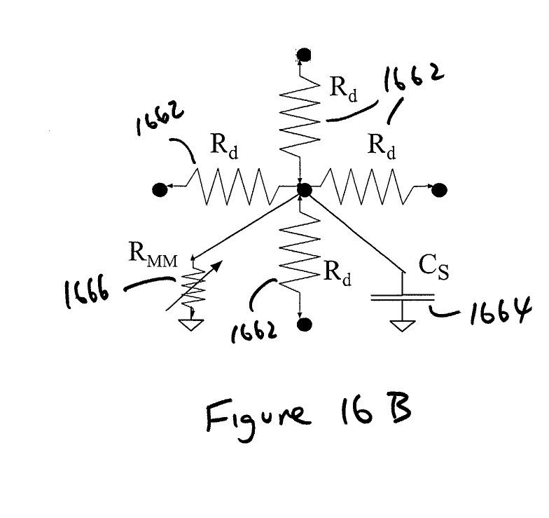

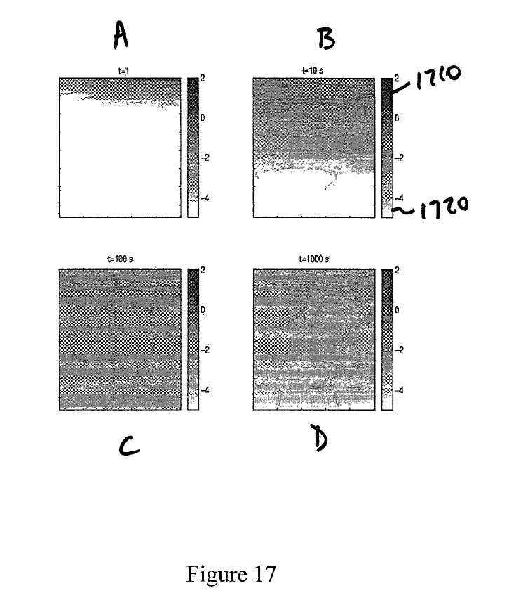

FIGS. 17A-17D show concentration profiles on a logarithmic grayscale for various times after the dose is applied. Darker regions 1710 are higher in concentration than are lighter regions 1720. FIG. 17A depicts the simulation one second after application. FIG. 17B depicts the simulation 10 seconds after application. FIG. 17C depicts the simulation 100 seconds after application. FIG. 17D depicts the simulation 1000 seconds after application. The drug is initially concentrated near the vehicle 1610 in the SC 1620, and diffuses toward the capillary 1650.

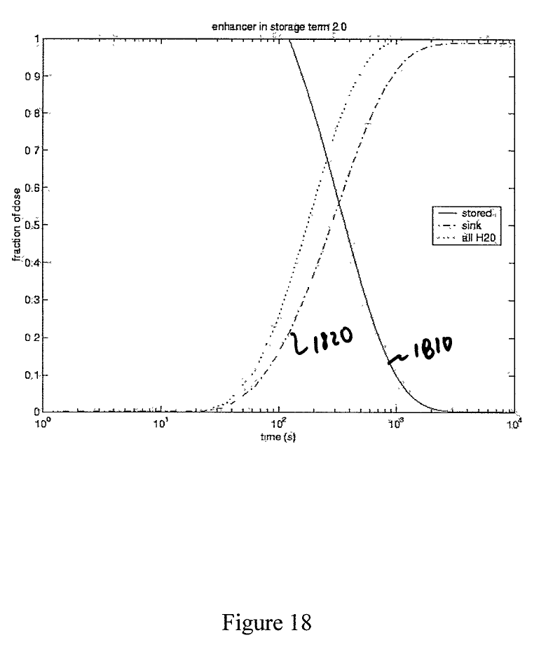

FIG. 18 shows the results of the simulation as the amount of drug stored in the simulation region (solid line 1810) and the amount of drug delivered to the capillary (dashed line 1820). Formula 10 of Kasting G. B., “Kinetics of Finite Dose Absorption Through Skin 1. Vanillylnonamide”, Journal of Pharmaceutical Sciences, Vol. 90, No. 2, 2001 defines the amount of drug delivered to the capillary in which the tissue is treated as a homogeneous material with the diffusive properties of water.

### EXAMPLE 12

### Electrical Detection of Arterial Plaque

This two-dimensional example shows the equipotentials resulting from one set of catheter electrodes being excited by an applied voltage, with the understanding that comparisons are made to other cases in which a series of different sets of catheter electrodes are excited, the detection basis being the distortion of the electric field by the plaque. The field distortion has an associated impedance or resistance change between the electrodes, which can be measured.

FIG. 19A is an optical coherence tomography image of a human coronary artery with a cholesterol rich vulnerable plaque. Simulation of electrical equipotentials in a model of a biological system that includes an electrode on a catheter within a blood vessel, with the model constructed from an optical coherence tomography image.

A two-dimensional model of a cross section of a human coronary artery with a cholesterol rich vulnerable plaque was created from the stained autopsy image of FIG. 19A. FIG. 19B is an illustrative two-dimensional model generated from the image shown in FIG. 19A. The dark area 1910 is muscle in the wall of the vessel, while the interior dark gray region 1920 represents fibrous plaque which slightly reduces blood flow. The resulting lattice was 100 nodes×125 nodes with an internodal spacing of 30 μm, so that the computational volume element is (30 μ)³, or 27,000 cubic μm. The impedance measurement was simulated with an electrode located on a catheter placed near the middle of the vessel. The steady-state simulation was performed using a resistor lattice as shown in FIG. 19C with the following resistivity values for different biological constituents of the geometry: rhoₗᵤₘₑₙ=0.7 ω m; rho_{cholesterol}=10.5 ω m; rho_{muscle}=2.05 ω m; rho_{fibrous tissue}=0.7 ω m. In FIG. 19C, R 1940 represents electrical resistance as given above.

A first electrode on the surface of the catheter has an area of 5 nodal spacings×1 nodal spacing (4,500 square micrometers). A second electrode occupies the entire simulation region boundary (405,000 square micrometers), representing a distant reference electrode. The applied voltage was 0.4 V. The resulting equipotential contours 1930 are shown superimposed on the model of this biological system.

### EXAMPLE 13

### Specific Absorption Rate and Heating

This two-dimensional example shows a model of a multicellular biological system that was created from a drawing,. The model is used with two lattices to first predict the electrical response, including the Specific Absorption Rate (“SAR”) spatial distribution, and to then predict the resulting spatial distribution of temperature changes.

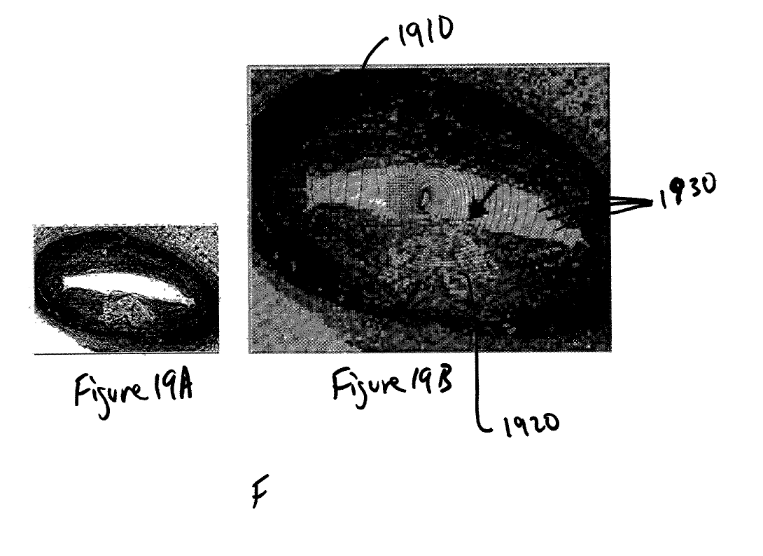

FIG. 20A is a drawing of a tissue. A two-dimensional model was created from the drawing of FIG. 20A, with a curved layer of seventeen (17) cells connected by tight junctions and underlying cells with approximately 15% extracellular fluid. In addition, the tissue also contains an invagination and a gap in the top cell layer. Under the top cell layer are thirty four (34) cells without tight junction connections but instead spaced by interstitial fluid. The simulation geometry was represented by a 262 node×242 node lattice with an internodal spacing of 0.4 μm. The plasma membrane was represented by a model containing representations for resting potential, channel conduction, pump conduction, and electroporation, as shown in EXAMPLE 1, FIGS. 2D and 2E. The intracellular medium resistivity was three times that of the extracellular resistivity.

The field was applied between the top and bottom boundaries as a sinusoidal voltage having 0.1 mV amplitude. The analysis was conducted over a range of frequencies. The SAR distribution was determined from the node voltages and the real part of the impedance between adjacent nodes. The nine panels of FIG. 20B(1)-20B(9) show an illustrative distribution of SAR for electric field frequencies from 10 Hz to 1 GHz in steps of a decade. The SAR values were input to a companion thermal lattice to calculate the temperature rise. The boundary elements were connected through a 10× resistor to a 37° C. reference temperature, representing a heat sink located 4 μm outside the perimeter of the electrical lattice. The nine panels shown in FIGS. 20C(1)-20C(9) depict illustrative isotemperature contours 2020 corresponding to the SAR images. The temperature values shown are in n ° C. over 37° C.

### EXAMPLE 14

### Moving Boundary with Transient Molecular Diffusion

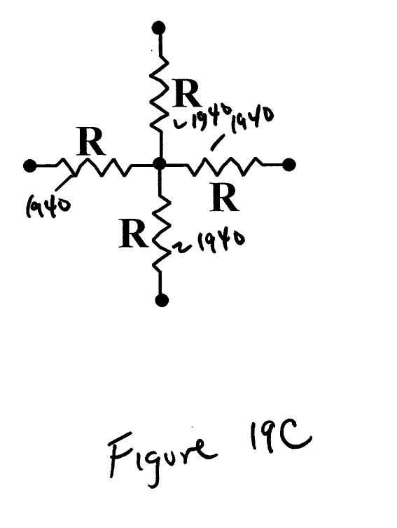

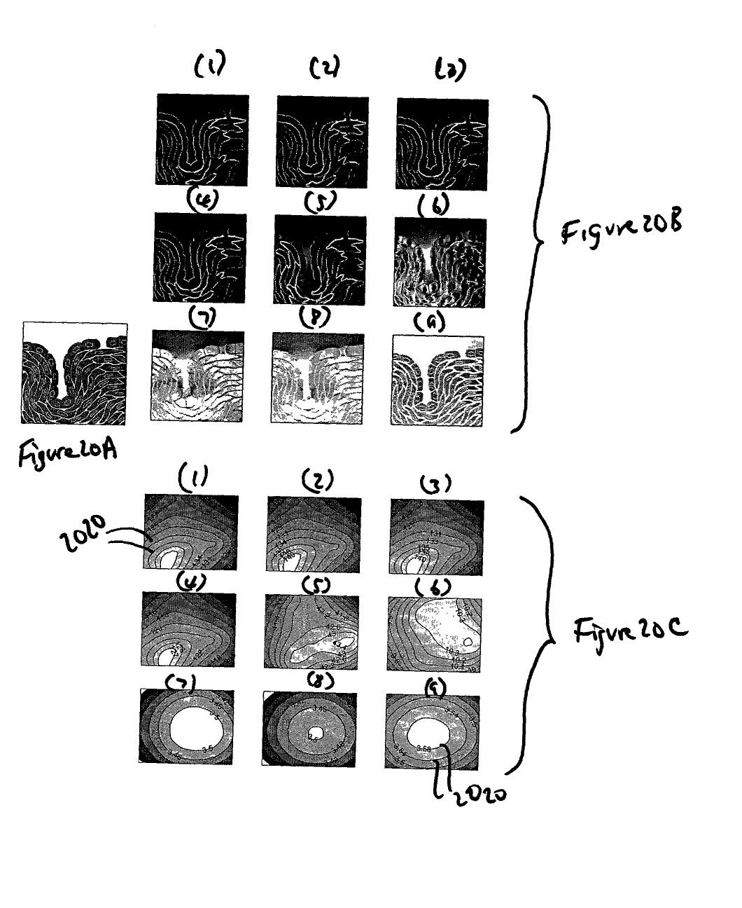

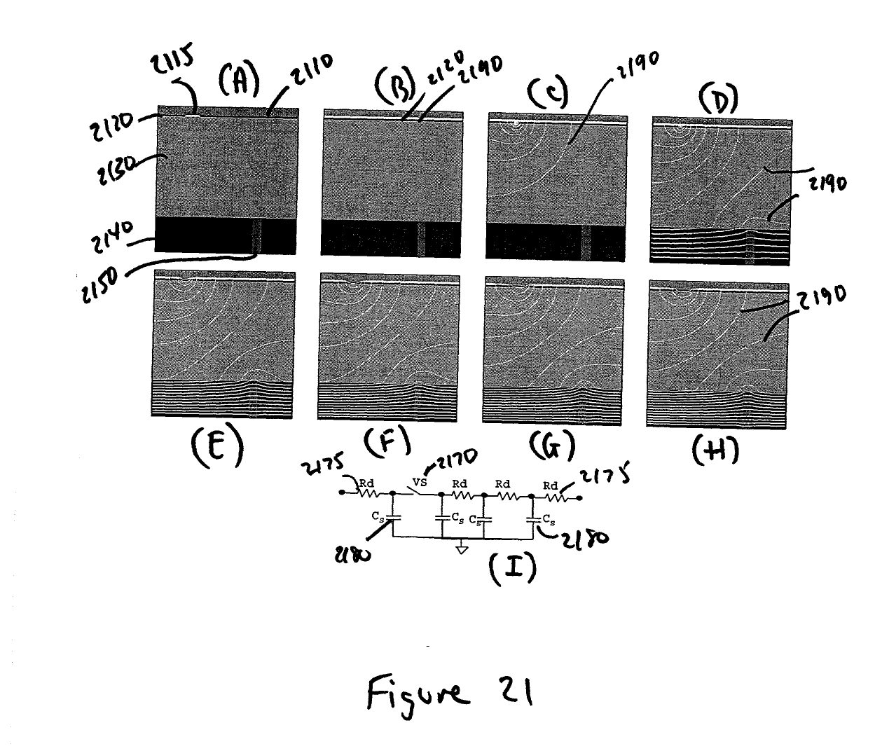

FIG. 21A is a diagram of a system that models the molecular transport of a chemical substance through a gradually opening valve. FIGS. 21B through 21H are diagrams showing the time evolution of the molecular transport process with time. FIG. 21I is an illustrative lattice circuit used to model the system with the gradually opening valve. This illustrative simulation represents the transport of drug molecules in an aqueous medium held in a reservoir 2110 (upper gray region) by a closed valve 2115 (white line) in a barrier, such as a septum (dark line) 2120. The valve 2115 and the barrier 2120 have the same thickness. The middle gray region represents an aqueous gel 2130 placed on top of skin 2140 having a stratum comeum (dark region at the bottom) containing a skin appendage 2150 (bottom gray region).

The valve 2115 is initially closed in FIG. 21B, gradually opening from left to right thus releasing the drug molecules from the reservoir. The simulation geometry volume was made up of 100 nodes×100 nodes with an intemodal spacing of 2 μm. The diffusion coefficient of drug in lipid was assigned a value of 1×10⁻¹³ m²/s and that of drug in water was assigned a value of 2×10⁻¹³ m²/s. The water lipid partition coefficient was g_{wl}=10, with the stratum corneum represented as a homogeneous medium with the properties of lipid (the main contribution to the stratum corneum barrier). The opening valve 2115 involves a moving boundary, represented by a series of transitions of 15 functional elements based on voltage dependent switches (Vₛ 2170) at regular, predetermined times within the valve region of the simulation space. The switch 2170 functions as a two-valued resistor, having a higher value corresponding to an impermeable barrier when it is open, and having a lower value corresponding to the diffusion coefficient of drug in water when it is closed. The switches 2170 comprising the valve region were initially assigned, in their open position, a very small value of the drug diffusion coefficient (1×10⁻¹⁶ m²/s), representing impermeability. The impermeable septum 2120 was also assigned a drug diffusion coefficient of 1×10⁻¹⁶ m²/s. The non-valve functional elements were represented by resistors Rd 2175 representing the diffusive transport. All the nodes, except those at the barrier, were connected to a reference node (electrical ground in the lattice circuit) by a capacitor, Cs 2180, to represent the storage of molecules.

A separate clock function was provided as part of the simulation, but not located within the lattice circuit volume, although electrically connected to the lattice circuit. This clock function consisted of a voltage ramp that started at V=0 at time t=0. The functional elements within the valve region were assigned voltage-sensitive switches Vs 2170, but with each switch assigned a progressively larger threshold as the switch location progresses from right-most to left-most location. During the simulation the first valve element diffusion coefficient changed from the very small to the value for the drug in water when the clock voltage reached the threshold of the first valve element. This represents the initial, partial opening of the valve, and resulted in initial diffusion of drug from the reservoir into the lower aqueous gel and subsequently into the stratum corneum 2140 with the appendage 2150. Further opening of the valve occurred as the clock voltage increased further, progressively switching the diffusion coefficient in valve functional elements located progressively to the left. Thus, the valve opening was simulated by a series of time-spaced switchings of the valve region permeability at a series of different locations, moving from right to left. While the valve was opening, drug molecules diffused from the reservoir 2110, through the opening valve 2115, into and through the gel 2130, and into and through the stratum comeum 2140 and the appendage 2150 to a sink located at the bottom of the model.

FIGS. 21C through 21H are panels that show the isoconcentration lines 2190 superimposed on the simulation geometry at different time points. FIG. 21B, the second panel in the top row, shows the lines 2190 collapsed at the septum 2120 since the valve 2115 is closed. In FIG. 21C, the valve 2115 is opened only slightly, corresponding to only one switch closed, demonstrated by the spreading contours 2160 around the open valve 2115. In FIGS. 21D through 21H, the valve is gradually opening up and the concentration gradient near the valve decreases. Since the appendage 2150 has a higher diffusion coefficient than the surrounding skin 2140, the concentration lines 2190 spread around the appendage 2150. In FIGS. 21C through 21H the number of switched valve functional elements is 1, 2, 4, 6, 8, and 15, with 15 corresponding to “fully open”. Since the appendage 2150 has a higher diffusion coefficient than the surrounding stratum comeum 2140, the concentration lines 2190 are inhomogeneous near the entrance to the appendage 2150.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for generating a computer-based digital representation of a physical system as an electrical circuit, comprising:
providing a three-dimensional lattice of circuit elements defined on a plurality of geometrical points, said three-dimensional lattice of circuit elements representative of a portion of a physical system to be simulated;
associating with said portion of the three-dimensional lattice a transport function representative of the physical system; and
providing a quantitative description of the transport function, so as to generate the computer-based digital representation of the electrical circuit simulation of the physical system.

2. The method of claim 1, further comprising providing an initial condition for at least one circuit element.

3. The method of claim 2, wherein the initial condition is a selected one of a voltage, a difference in voltage, a current, and a charge.

4. The method of claim 3, wherein the selected one of a voltage, a difference in voltage, a current and a charge represents a physical quantity characteristic of the physical system.

5. The method of a claim 4, wherein said physical quantity characteristic of said physical system is at least one of a chemical quantity, a physical quantity, and a biological quantity.

6. The method of claim 5, wherein said at least one of a chemical quantity, a physical quantity, and a biological quantity is a selected one of an amount of material, a concentration of a first material in a second material, a flow of material, a flux of material, a temperature, a pressure, a volume, a time, a frequency, an intensity of electromagnetic radiation, a wavelength of electromagnetic radiation, a potential difference, a diffusion coefficient, and a gradient.

7. The method of claim 1, further comprising solving the circuit to determine a behavior of the circuit.

8. The method of claim 7, further comprising translating a value obtained from solving the circuit to a physical quantity indicative of a solution of the transport function in the physical system to be simulated.

9. The method of claim 1, wherein the plurality of geometrical points is based on a selected one of an image, a drawing, and a shape.

10. The method of claim 9, wherein the shape is a selected one of a graphical shape, a shape defined by an equation, and a shape defined by a numerical representation.

11. The method of claim 9, wherein the shape is a member of a library of shapes.

12. The method of claim 1, wherein the physical system comprises a system having a biological component.

13. The method of claim 1, wherein the physical system comprises a system having a chemical component.

14. A computer-based digital system for generating a representation of a physical system as an electrical circuit, comprising:
a lattice module that provides a three-dimensional lattice of circuit elements defined on a plurality of geometrical points, the three-dimensional lattice of circuit elements representative of a portion of a physical system to be simulated;
a function module that associates a transport function representative of the physical system with a portion of the three-dimensional lattice; and
a description module that provides a quantitative description of the transport function in the portion, so as to generate the computer-based digital representation of the simulated electrical circuit as a physical system.

15. The system of claim 14, further comprising an initiation module that provides an initial condition for at least one circuit element.

16. The system of claim 15, wherein the initial condition is a selected one of a voltage, a difference in voltage, a current, and a charge.

17. The system of claim 16, wherein the selected one of a voltage, a difference in voltage, a current and a charge represents a physical quantity characteristic of the physical system.

18. The system of a claim 17, wherein said physical quantity characteristic of said physical system is at least one of a chemical quantity, a physical quantity, and a biological quantity.

19. The system of claim 18, wherein said at least one of a chemical quantity, a physical quantity, and a biological quantity is a selected one of an amount of material, a concentration of a first material in a second material, a flow of material, a temperature, a pressure, a volume, a time, a frequency, an intensity of electromagnetic radiation, a wavelength of electromagnetic radiation, a potential difference, a diffusion coefficient, and a gradient.

20. The system of claim 14, further comprising a solution module that solves the circuit to determine a behavior of the circuit.

21. The system of claim 20, further comprising a translation module that translates a value obtained from solving the circuit to a physical quantity indicative of a solution of the transport function in the physical system to be simulated.

22. The system of claim 14, wherein the plurality of geometrical points is based on a selected one of an image, a drawing, and a shape.

23. The system of claim 22, wherein the shape is a selected one of a graphical shape, a shape defined by an equation, and a shape defined by a numerical representation.

24. The system of claim 22, wherein the shape is a member of a library of shapes.

25. The system of claim 14, wherein the physical system comprises a system having a biological component.

26. The system of claim 14, wherein the physical system comprises a system having a chemical component.

27. A computer-based digital system for generating a representation of a physical system as an electrical circuit, comprising:
a means for providing a three-dimensional lattice of circuit elements defined on a plurality of geometrical points, the three-dimensional lattice of circuit elements representative of a portion of a physical system to be simulated;
a means for associating a transport function representative of the physical system with a portion of the three-dimensional lattice; and
a means for providing a quantitative description of the transport function in the portion, so as to generate the computer-based digital representation of the simulated electrical circuit as a physical system.

28. The system of claim 27, further comprising a means for providing an initial condition for at least one circuit element.

29. The system of claim 28, wherein the initial condition is a selected one of a voltage, a difference in voltage, a current, and a charge.

30. The system of claim 29, wherein the selected one of a voltage, a difference in voltage, a current and a charge represents a physical quantity characteristic of the physical system.

31. The system of a claim 30, wherein said physical quantity characteristic of said physical system is at least one of a chemical quantity, a physical quantity, and a biological quantity.

32. The system of claim 31, wherein said at least one of a chemical quantity, a physical quantity, and a biological quantity is a selected one of an amount of material, a concentration of a first material in a second material, a flow of material, a flux of material, a temperature, a pressure, a volume, a time, a frequency, an intensity of electromagnetic radiation, a wavelength of electromagnetic radiation, a potential difference, a diffusion coefficient, and a gradient.

33. The system of claim 27, further comprising a means for solving the circuit to determine a behavior of the circuit.

34. The system of claim 29, further comprising a means for translating a value obtained from solving the circuit to a physical quantity indicative of a solution of the transport function in the physical system to be simulated.

35. The system of claim 27, wherein the plurality of geometrical points is based on a selected one of an image, a drawing, and a shape.

36. The system of claim 35, wherein the shape is a selected one of a graphical shape, a shape defined by an equation, and a shape defined by a numerical representation.

37. The system of claim 35, wherein the shape is a member of a library of shapes.

38. The system of claim 27, wherein the physical system comprises a system having a biological component.

39. The system of claim 27, wherein the physical system comprises a system having a chemical component.
